(19) United States
(12) Patent Application Publication
(10) Pub. No.: US 2026/0214189 A1
(43) Pub. Date: Jul. 23, 2026

(54) ROBOTIC SURFACE MODIFICATION SYSTEMS AND METHODS

(71) Applicant: 3M INNOVATIVE PROPERTIES COMPANY, St. Paul, MN (US)

(72) Inventors: Rudy M. Lawler, Sioux Falls, SD (US); Sarah A. Medley, St. Paul, MN (US); Robert A. Knutson, Lakeville, MN (US); Jonathan B. Arthur, Hudson, WI (US); Simron Thapa, Cottage Grove, MN (US); Alireza Ghaderi, Woodbury, MN (US)

(21) Appl. No.: 19/143,018

(22) PCT Filed: Dec. 19, 2023
(86) PCT No.: PCT/IB2023/062938

§ 371 Date: Jun. 25, 2025

Related U.S. Application Data
(60) Provisional application No. 63/477,229, filed on Dec. 27, 2022.
(60) Provisional application No. 63/584,506, filed on Sep. 22, 2023.

(51) Int. Cl. H04N 9/31; G01B 11/25; G01N 21/88; G01N 21/95

(52) U.S. Cl. CPC H04N 9/3185; G01B 11/25; G01N 21/8806; G01N 21/9515; H04N 9/3176; G01N 2201/061; H04N 9/3182

(57) ABSTRACT

An imaging system for a reflective surface is presented that includes a first light source, mounted to a robotic arm, a second light source, different from the first light source, mounted to the robotic arm. The system also includes an imaging device positioned to capture images of the reflective surface. The first light source, the second light source and the imaging device are mounted on a robotic arm. The first light source is positioned, with respect to the imaging device, such that a field of view of the imaging device captures specular reflections from the first light source,

### BACKGROUND

Surface modification on specular surfaces presents challenges for imaging, surface trajectory design, and evaluation pre and post-modification.

### SUMMARY

An imaging system for a reflective surface is presented that includes a first light source, mounted to a robotic arm, a second light source, different from the first light source, mounted to the robotic arm. The system also includes an imaging device positioned to capture images of the reflective surface. The first light source, the second light source and the imaging device are mounted on a robotic arm. The first light source is positioned, with respect to the imaging device, such that a field of view of the imaging device captures specular reflections from the first light source.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface modification system in which embodiments of the present invention are useful.

FIG. 2 illustrates a method of surface modification in accordance with embodiments herein.

FIGS. 3A-3E illustrate images captured by an image capturing system as described in embodiments herein.

FIGS. 4A and 4B illustrate one embodiment of a robotic repair unit with a surface modification imaging system.

FIGS. 5A-5B illustrates a schematic of different lighting arrangements that might be useful for different evaluations of a surface.

FIGS. 6A-6D illustrate different configurations of an imaging system in accordance with embodiments herein.

FIGS. 7A-7B illustrate one embodiment of an image capture system that can be mounted to a robotic surface modification unit in accordance with embodiments herein.

FIG. 8 illustrate different structured light patterns that can be placed over a backlight, for example, to provide structured illumination for the imaging system.

FIGS. 9A-10B illustrate the results of images captured using systems herein and processed using systems and methods described herein.

FIGS. 11A-1 to 11F illustrate images of reflected gridded light on surfaces generated using systems and methods herein.

FIGS. 12A-2B illustrates a static structured light set and illuminated specular surface up in accordance with embodiments herein.

FIGS. 13A-13G illustrate images of a surface captured using static structured light with a grid pattern.

FIG. 14 illustrates a diffuser plate stack that may be used in some embodiments described herein.

FIGS. 15A and 15B illustrate a schematic of a surface imaging system in accordance with embodiments herein.

FIGS. 16A-16B illustrate a schematic of an outward facing surface imaging system in accordance with embodiments herein.

FIGS. 17A-17B illustrate a schematic of a binocular normal facing surface imaging system in accordance with embodiments herein.

FIG. 18 illustrates a schematic of a flat dome light surface imaging system in accordance with embodiments herein.

FIG. 19 illustrates a schematic of a surface imaging system.

FIG. 20 is a repair strategy generation system architecture.

FIGS. 21-22 show examples of mobile devices that can be used in the embodiments shown in previous Figures.

FIG. 23 is a block diagram of a computing environment that can be used in embodiments shown in previous Figures.

### DETAILED DESCRIPTION

Recent advancements in imaging technology and computational systems have made feasible the process of clear coat inspection at production speeds. In particular, stereo deflectometry has recently been shown to be capable of providing images and locations of paint and clear coat defects at appropriate resolution with spatial information (providing coordinate location information and defect classification) to allow subsequent accurate relocation and automated spot repair.

However, particularly in the automotive industry, many of the surfaces that contain defects are not flat. And the vehicle may move between an initial inspection location and a repair location. It is important to verify the exact position of the vehicle so that an exact defect location is known. It may also be important to recharacterize, or confirm initial characterization, of the defect closer to the time a repair happens.

Systems and methods herein provide for imaging of a surface using a compact end-of arm system on a robotic surface modifying unit. In some embodiments, the imaging system is mounted near a robotic surface modifying tool on the robotic unit. Having a system that can be mounted on an end of the same robotic arm as a surface modifying tool (as opposed to on a separate robotic unit) provides significant advantages including in-situ measurement during a surface modification operation and reduced error in movement transition between the tool and the imaging system. However, the imaging system has to be compact enough such that a robotic arm can maneuver a surface modifying tool into position for a surface modifying operation. The images may be processed in-situ to generate a surface characterization, a surface modification trajectory, etc. The same (or a different) imaging system may be used post-surface modification operation to recharacterize the surface to understand whether the surface modification is sufficient. For example, a vehicle may have a clearcoat defect in an area on a surface that, post-repair (e.g. sanding and polishing), has significant haze, which may be significant enough to be considered unacceptable aesthetically.

However, while systems and methods are described herein that envision an end-of-arm imaging system, it is expressly contemplated that, in some embodiments, the imaging system may be on a separate robotic unit. In some embodiments, an end-of-arm imaging system may be mounted to the same robotic arm as a surface modification tool, but in a separate mount position.

As used herein, the term “vehicle” is intended to cover a broad range of mobile structures that receive at least one coat of paint and/or clear coat during manufacturing. While many examples herein concern automobiles, it is expressly contemplated that methods and systems described herein are also applicable to trucks, trains, boats (with or without motors), airplanes, helicopters, motorcycles, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification.

As used herein, the term “defect” refers to an area on a worksurface that interrupts the visual aesthetic. For example, many vehicles have specular, or reflective, surfaces that may appear shiny or metallic after painting is completed. A “defect” can include debris trapped within one or more of the various paint layers on the work surface. Defects can also include smudges in the paint, excess paint including smears or dripping, as well as dents. As used herein, “defect” includes both aesthetic interruptions occurring during paint application or during a repair process. A surface may have some haze on a surface, for example, which is made worse during a defect repair operation. Or, a surface may have no significant haze in an area containing a defect (e.g. trapped debris, scratch) prior to a repair operation, but a level of unacceptable haze post-repair of said defect.

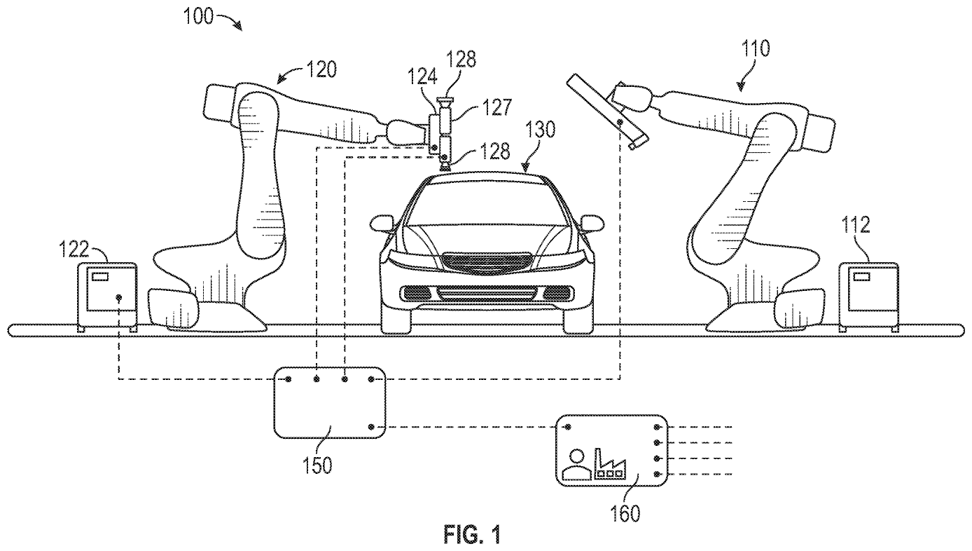

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two tools 128, as further described in co-pending U.S. Provisional Patent Application 62/940950 filed on Nov. 27, 2019. It is also noted that end effector 126 includes an imaging system 127 positioned such that rotation, or linear movement of end effector 126 can allow for switching between one of tools 128 and imaging system 127. However, other arrangements are also expressly contemplated. For example, while FIG. 1 illustrates a repair unit 120 operating simultaneously with imaging system 110, it is expressly contemplated that repair unit 120 operates at least at a time delay from imaging system 110, such that at least some movement of repair unit 120 is informed by data collected from repair unit 110.

The first of the two main challenges, inspection of vehicle 130 by inspection unit 110, is interesting due to the nature of the underlying problem domain. In general, the surface of interest is very large in comparison to the defects themselves, with the difference being multiple orders of magnitude. This results in trade-offs between field of view and resolution when it comes to sensor selection as well as lens selection, crucial for creating a required angular field of view. Additionally, each paint layer of the finishing process (e-coat, primer, paint, clear coat, etc.) differs in its visual appearance with specularity being particular noteworthy. Highly specular surfaces (i.e., high-gloss or highly reflective surfaces) pose unique imaging challenges. These issues together make inspection difficult. Recent progress in the last few years has been made in this area making use of increasing computational resources, resulting in the availability of several commercial solutions. The presence of a sufficiently capable inspection system 110 is important for identifying defects for repair by repair unit 120.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

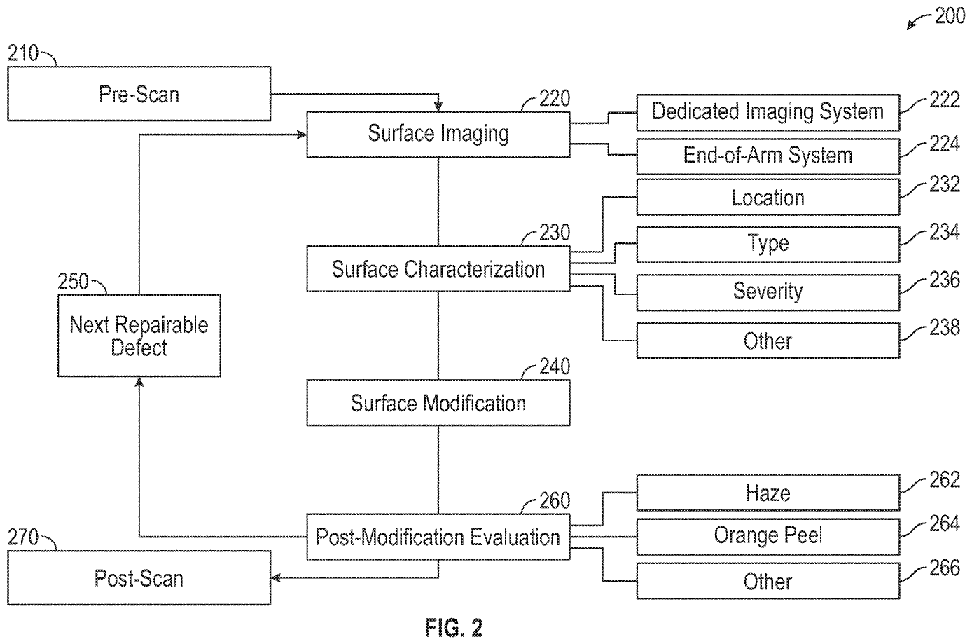

It is expressly noted that, throughout the present description, the example of surface modification of a vehicle surface to remove paint-related defects from a surface is presented as one potential use case. However, other surface modifications are expressly contemplated, such as other abrasive operations (sanding, grinding), other additive processes (e.g. additive manufacturing, adhesive deposition, etc.), or subtractive processes (material removal, cutting, etc.) FIG. 2 illustrates a method of surface modification in accordance with an embodiment of the present invention. While method 200 is described in the context for surface defect repair on a vehicle, it is expressly contemplated that other use cases may also benefit from systems and methods herein.

In block 210, an initial scan of the surface to be modified is done. This initial scan may be done at a first location, for example in the vehicle repair context, at an inspection station.

As illustrated in FIG. 2, the steps of imaging 220, surface characterization 230, surface modification 240, and post-modification evaluation, are repeated for a number of defects on the surface. In the vehicle context, a surface may have multiple discrete defects needing repair on a surface. However, some detected defects during and the initial scan of block 210 may not need repair, or may not be repairable by an on-site repair unit. For the number of defects that can be repaired by a robotic repair unit, the steps 220, 230, 240, and 260 repeat until all defects are repaired to an acceptable level, or as allowed by production/timing constraints. An acceptable level may be determined, for example, by an industry accepted size, a manufacturer quality tolerance, or another standard such as visibility by the human eye, etc.

In block 270, a second scan of the entire surface may be completed, for example by the same imaging system as that of block 210, using the imaging system of blocks 220-260, or another imaging system.

In the paint defect repair context, the scan conducted in block 210 is often used to locate defects on a surface, not necessarily to characterize the defects in detail, or to select a surface modification sequence for addressing detected defects. The initial scan of block 210 may be used, for example to determine which defects detected need to be repaired, and can be repaired by an on-site robotic surface modification unit.

In block 220, local surface imaging is conducted. In the context of vehicle defect repair, a dedicated imaging system 222 may capture information about the surface at the point of the detected defect. Dedicated imaging system 222 may be an imaging system separate from a robotic surface modification unit, or may be part of an end of arm system 224 of a robotic surface modification unit.

In block 230, characterization of the image surface is done. Characterization may include confirming an exact location 232 on a surface needing modification. For example, defect location may be confirmed with a high degree of accuracy in three-dimensional space. Additionally, a surface modification sequence may be generated, for example based on a type of modification sequence 234 necessary. For example, a scratch is repaired by a robotic repair unit differently than a bump caused by trapped debris. Additionally, a crater is repaired in yet another manner. The surface modification sequence 234 may also be selected based on the severity 236 of the detected defect. For example, large piece of trapped debris may require additional pressure, longer contact time, or a different abrasive article, then a small piece of trapped debris. Other surface characterization considerations 238 may also be important, such as anticipated vehicle use, status of other layers of paint, etc. For example, an initial orange peel characterization may be done on the surface around a detected defect, to ensure that a selected surface modification sequence maintains, or blends into the orange peel around the surface.

In block 240, a surface modification operation is conducted. The surface modification 240 may be conducted based on the surface modification sequence selected in block 230, or based on other considerations. The surface modification 240 may be either an additive or subtractive modification based on a need of a work surface being modified. The surface modification 240 may include a trajectory that includes a path consisting of a series of waypoints, between each waypoint a surface modification tool travels at a speed, angle, and applied pressure.

In block 260, after a surface modification sequence is completed, a post modification evaluation may be done of the surface. It is expressly contemplated that post modification evaluation 260 may be done using the imaging system used in block 220, the imaging system used in block 210, or another imaging system. However, as described herein, an end-of-arm system 224 provides sufficient flexibility to allow for the same imaging system to be used in blocks 220 and 260, which may increase efficiency and accuracy in addressing a number of repairable defects on a surface. Post modification evaluation 260 may include evaluating and measuring the surface for a number of features, for example haze 262 introduced on a surface as a result of the surface modification, whether or not orange peel 264 has been disrupted, or other features 266, for example introduced scratch as, etc.

In block 250, the defect area is inspected to determine whether the repair is sufficient. If additional repair is needed, method 200 may receive new instructions, as indicated by arrow 260, and the method may repeat. Inspecting a defect repair may include capturing post-repair images 252, which may be presented to a repair operator or saved as needed. Inspecting may also include validating the repair, as indicated in block 254, which may include comparing pre-and post-repair images, detecting whether a defect will be visible / noticeable to the human eye, or another suitable validation technique. In some embodiments, captured images are analyzed by an operational system or quality assurance, tracking and process management.

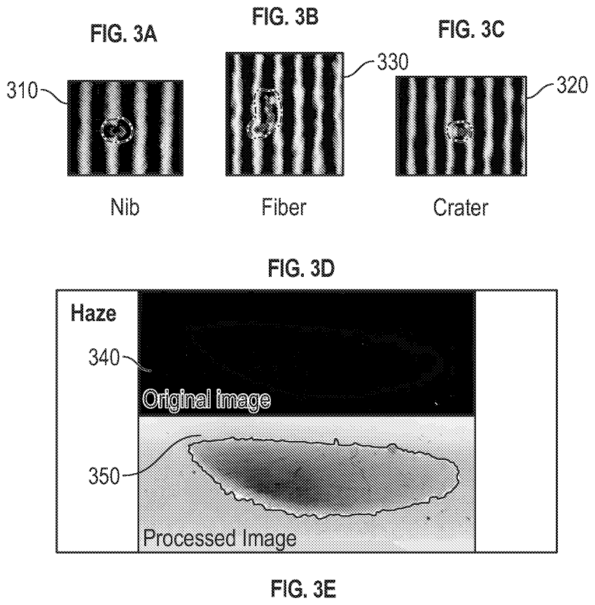

FIGS. 3A-3E illustrate images captured by an image capturing system as described in embodiments herein. As discussed above, an image capturing system may be mounted on an end effector of a robotic repair unit. However, other locations are also possible in other embodiments.

FIG. 3A illustrates a structured light image 310 of a surface containing a defect. The defect illustrated an image 310 is a nib. FIG. 3B illustrates a structured light image 330 of a surface containing a defect. The defect illustrated in image 330 is a trapped fiber. FIG. 3C illustrates a structured light image 320 of us surface containing a defect. The defect illustrated in image 320 is a crater.

FIGS. 3D and 3E illustrate an original image 340, and a processed image 350 of a surface after a surface modification has been completed. As illustrated in image 350, it is possible using systems and methods herein to determine a boundary of the surface modification and evaluate the amount of Haze (higher being illustrated by darker portions of the image) introduced to the surface by the surface modification. Haze is caused by the non-specular reflections of surface scratches which scatter the incoming light, rather than reflecting through resonance.. It is noted that the illustrated images are inverted images. In embodiments herein, more reflected light is received from the micro-scratches. However, the image is inverted for ease of human viewing. It is expressly contemplated that analysis may be done of the captured images or the inverted images.

Systems and methods herein enable the automatic detection of defects on a specular surface with a singular image without moving the object. Currently, specular surface inspection systems are complex and often involve multiple cameras, light or motion of the object with respect to the one or more cameras. Systems and methods herein allow for coordination of machine vision equipment, image capture under different illumination conditions, and identification of features and defects using machine vision algorithms. Illustrated herein are systems and methods for sub-millimeter defects on specular surfaces. However, systems and methods herein may also be used to address other challenges with other surface conditions.

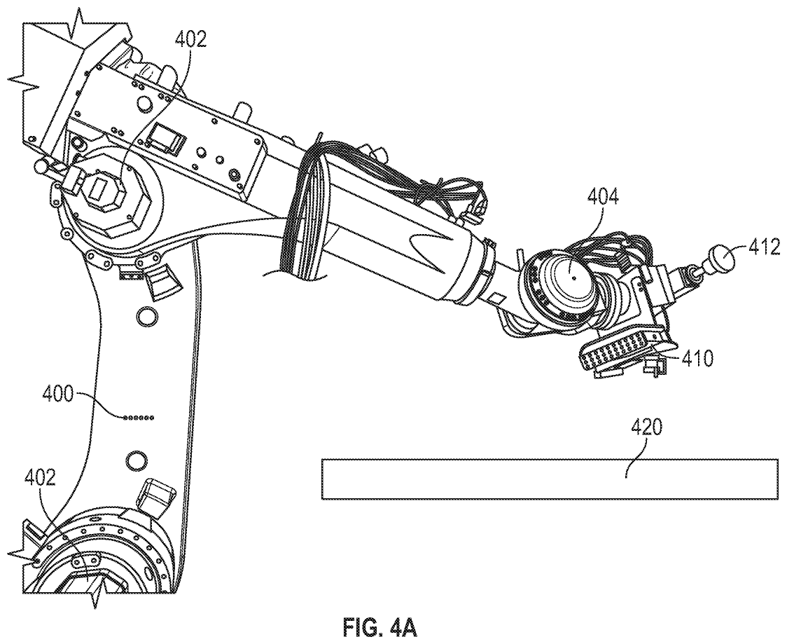

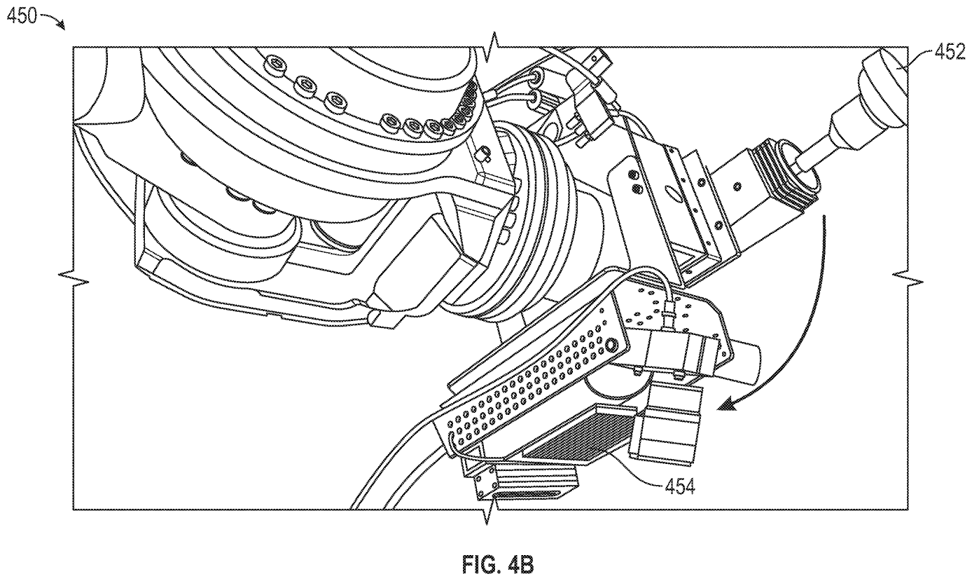

FIGS. 4A and 4B illustrate one embodiment of a robotic repair unit with a surface modification imaging system. A repair robot 400 may include one or more pivot points 402 that allow for the robotic arm to approach a surface to be modified. A rotational joint 404 may allow for an end effector, with an imaging system as described herein, to navigate a curved or irregular surface to obtain images needed for constructing and evaluating a surface modification sequence. The robotic arm 400 illustrated in FIG. 4A has multiple degrees of freedom that allow for approach and surface modification of a surface.

While a flat surface 420 is illustrated in FIG. 4A, is expressly contemplated that curved or angular surfaces may also benefit from use of systems and methods herein, where traditional bulkier and more complex systems may not be able to maneuver into place to capture the images needed for clearcoat defect repair.

An end effector of robot 400 includes one or more tools 410 and an imaging system 410. 412 may be rotationally switched with imaging system 410 such that, following a surface modification operation with tool 412, imaging system 410 may be moved into place to capture images for a surface modification evaluation.

FIG. 4B illustrates a close-up view 450 of an end of arm system. FIG. 4B illustrates how a tool 452 can be rotated into place, displacing imaging system 454. Similarly, imaging system 454 can be rotated into place as needed, e.g. after a surface modification operation with tool 452 has been completed.

As will be discussed in greater detail with respect to later figures, the robot controller responsible for moving tool 452 and imaging system 454 into and out of position is controlled by controller that selectively triggers a scattered light system, the image capture system, and movement of the robotic system generally. In some embodiments, a system has multiple controllers-e.g. a controller that physically moves a robot into place, a repair controller that causes the robotic unit to execute a selected repair strategy, and/or an imaging controller which may move components in or out of position, turn lights on or off, capture an image, etc.

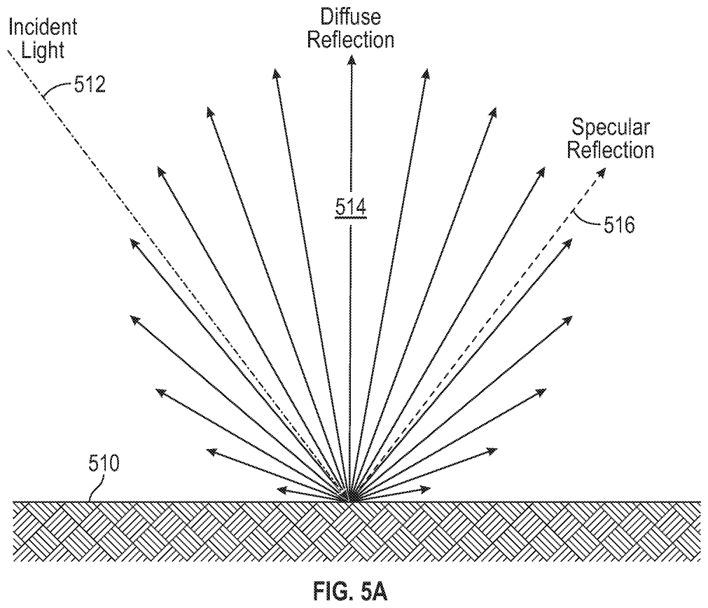

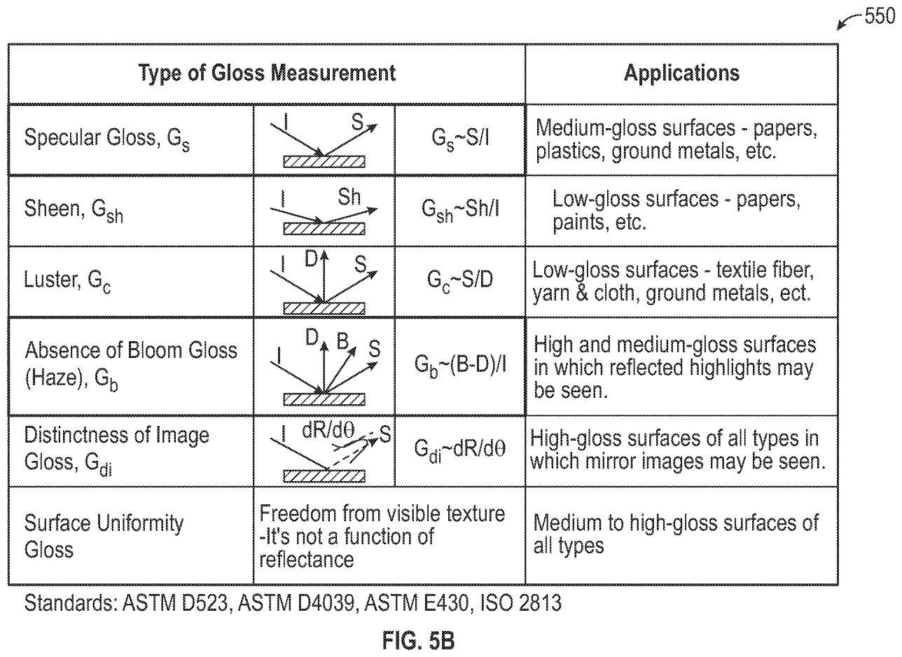

Systems and methods herein use different lighting arrangements in order to obtain different images of a surface prior to a surface modification. FIG. 5A illustrates a schematic of different lighting operations that might be useful for different evaluations of a surface. An incident light 512 is projected on a surface 510 at an incident angle. Light may then reflect off of surface 510 either as diffuse reflection 514, or as a specular reflection 516. Diffuse reflection of incident light 512 bounces off the surface in a number of directions, and at a variety of angles, as illustrated in FIG. 5A. Specular reflection 516 reflects off of surface 510 at an opposite angle of the incident light angle.

FIG. 5B illustrates a chart 550 of different types of light reflection angles that different measurement techniques may use to characterize a surface. Chart 550 also illustrates the potential applications for which each measurement technique may be particularly useful. It is noted that chart 550 is not intended to be an exhaustive list. It is noted that systems and methods herein are described as being configured to measure specular gloss and/or haze. However, it may be possible to adjust the relative positioning of a camera to a light source and measure sheen, luster, gloss distinctiveness, or surface uniformity using systems and methods herein.

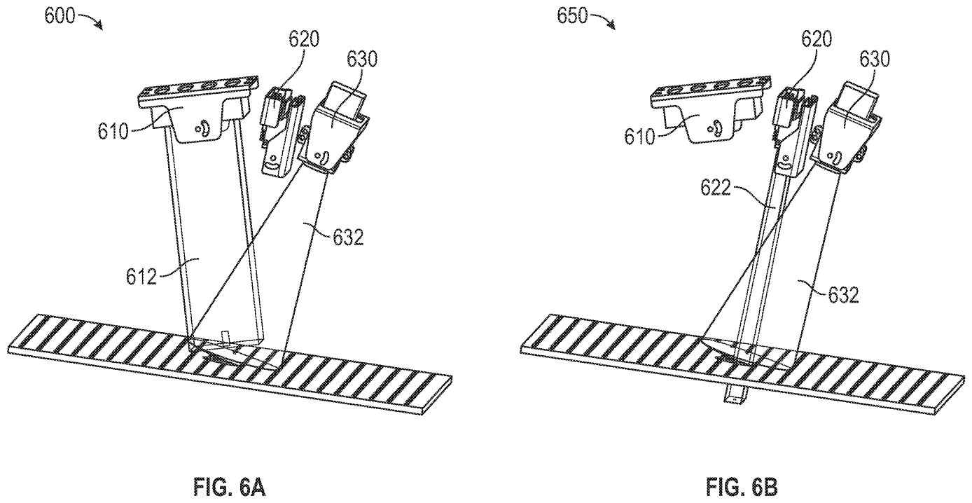

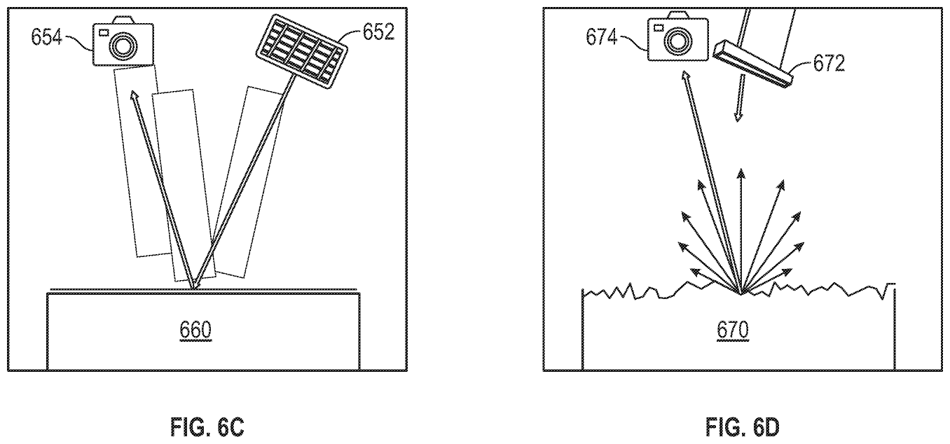

FIGS. 6A-6B illustrate different configurations of a single imaging system, illustrating how different types of images can be obtained using a single imaging system. Setup 600 illustrates a backlight 610 angled with respect to a surface, projecting light as illustrated by light projection 612. An image capture device 630 is also angled at the surface, with the field of view 632.

Setup 650 illustrates the area backlight off, and instead a high intensity light 620 is projected at the surface. Setup 610 may be useful for specular reflections, e.g. characterizing defects. Setup 650 may be useful for capturing an image using scattered light illumination, which is particularly useful for capturing haze.

FIGS. 6C and 6D illustrate schematics of how imaging systems in 6A and 6B, respectively, can be used to characterize a surface. In FIG. 6C, a light source 652 is angled with respect to a surface 660 and image capture device 674, such that such that a projected ray of light is directed toward surface 660 and reflected back to camera 654, providing a specular reflection from surface 660 for capture. In FIG. 6D, a light source 672 is angled with respect to a surface 670 and image capture device 674 such that a projected ray of diffuse light reflects from surface 670 in a number of directions, such that a diffuse reflection is provided to image capture device 674.

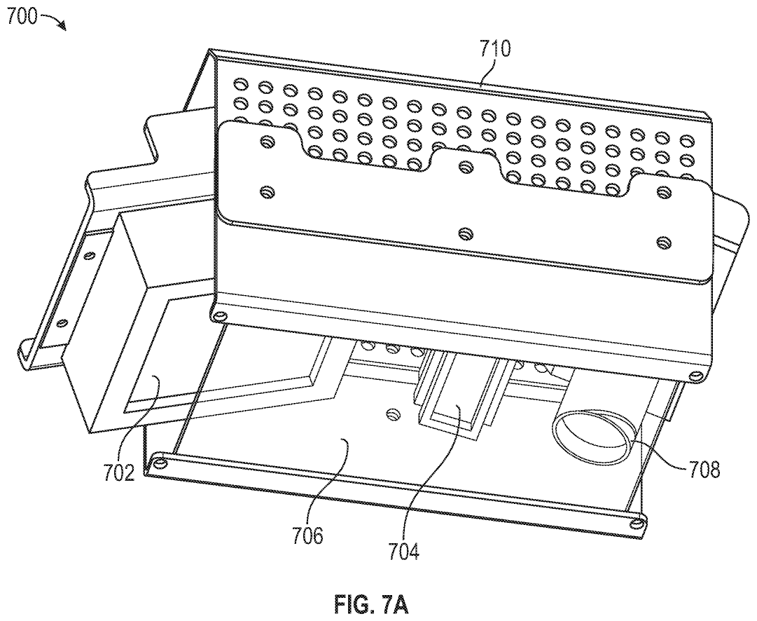

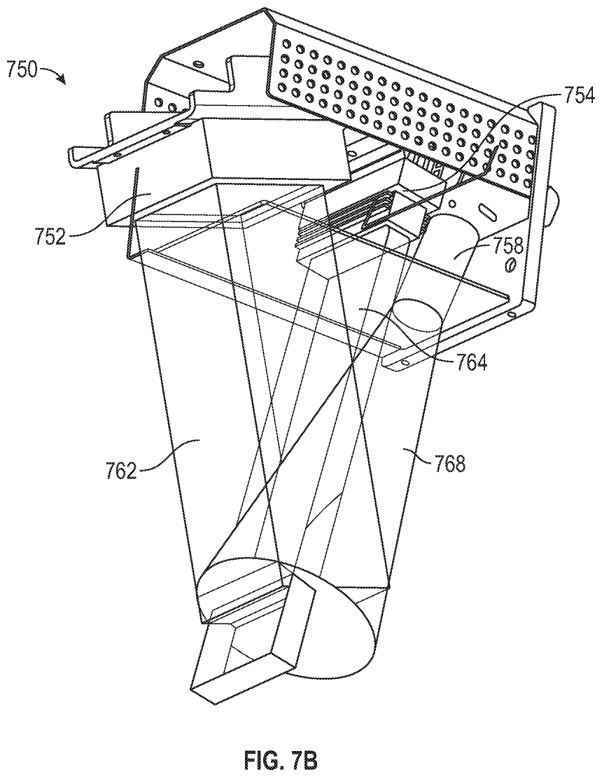

FIGS. 7A-7B illustrate an embodiment of an image capture system 700 that can be mounted to an end effector of a robotic surface modification unit. Image capture system 700 includes an image capturing device 708, such as a camera. The image capture device may also include one or more lenses, e.g. a lens stack, and may have significant vibration resistance. Vibration resistance is of particular importance in the clearcoat defect repair use case and that the robotic repair unit may be moving laterally to follow a vehicle, or to move into place for image capturing system 708 to capture necessary images. System 700 may also include a number of lighting options, such as an area backlight 702 and/or a high-intensity line light 704. As described herein, area backlight 702 may be used with one or more light structured light patterns. Area backlight 702 may also project light at a number of different intensities, depending on the application. In some embodiments, area backlight 702 can also change a spectral profile-e.g. by adding or removing a color feature, for example.

A mount 710 is designed to mount the image capture system 700 to the end effector, for example directly or using an attachment plate. System 700 may also include a transparent cover 706 that protects backlight 702, high intensity light 704, and image capturing device 708 from debris, splatter, etc., e.g. a glass or plastic cover. High intensity light 704 is illustrated as a line light, however it is expressly contemplated that some embodiments utilize high intensity spot lights or projectors.

FIG. 7B illustrates system 750 in operation, with part of the mounting system removed for increased clarity. Area backlight 752 projects a diffuse light 762 that overlaps with the field of view 768 projected from image capturing device 758. While FIG. 7B illustrates an embodiment where area backlight 752 and high-intensity line light 754, which projects a higher intensity band of light 764, are in operation simultaneously, it is expressly contemplated that, for many use cases, only one may be used.

Additionally, FIG. 7B illustrates area backlight 752, high-intensity line light 754 and image capturing device 758 at an angle with respect to each other. The angle of any of component 752, 754, 758 may be fixed, or maybe adjustable in some embodiments.

Systems and methods herein utilize novel lighting techniques to detect clearcoat defects with directional illumination or surface defects with scattered light illumination. Operation of each of the components is controlled by a robot controller (not shown in FIGS. 7A-7B). System 750, for example, is mounted to robotic surface modification unit in a suitable position with respect to the surface. Surface defects created by microscopic scratches, e.g. haze, may be more visible when using back scatter lighting systems. This can be accomplished using a line light at an angle as discussed in FIG. 5A. It may also be possible to use on-axis specular reflections and observing scatter rings.

It is important for systems and methods described herein to maintain alignment of the field of view and the surface being imaged. For specular surfaces, the main rays of light reflect off the surface such that an angle of reflectance is equal to an angle of incidence. Because of specular reflection, the incident and reflected light are within a plane. The main axis of the camera/lens therefore should be set at the correct position and orientation such that this axis intercepts those main rays of light with accuracy. The field of view needs to be in line with the normal vector from the surface area of interest, e.g. the area containing a defect. It may also be important to maintain stability of an imaging system such that the alignment remains correct.

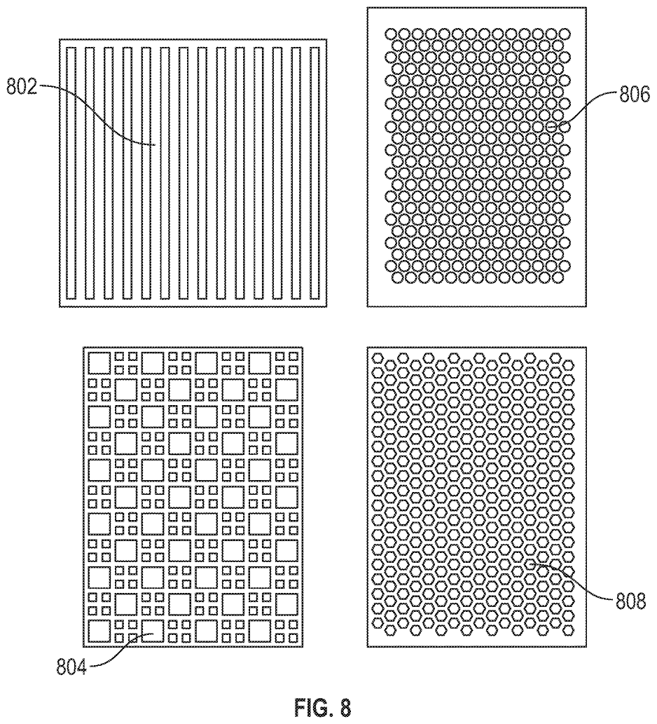

FIG. 8 illustrate different structured light patterns that can be used to provide structured illumination for the imaging system. In some embodiments, one or more of the grid patterns illustrated in FIG. 8 is placed over the backlight, as a mask, and remains in place for an entire surface modification process, e.g. repair of all of the defects on a given vehicle. However, in some embodiments, a grid pattern may be removable from a backlight, such that different grid patterns could be used for repair of different detected defects. In some embodiments, the pattern is incorporated into the backlight, such that it is not easily removed or exchanged in between operations.

With a fixed pattern, it is possible to obtain images at a higher rate of speed. Using only one grid pattern also allows for the entire process to be more efficient, reducing cycle time in between surface modification operations, as the analytical process is much simpler for a single grid pattern, than for a traditional complex structured light pattern.

For example, some prior art systems require a 3′×4′ high intensity display screen, through which multiple patterns are presented. While each pattern is presented, an image is taken. The images must then be analyzed and combined to provide a single surface map. Systems and methods herein can obtain the surface information necessary to conduct a surface modification sequence with a sequence of images, obtained with one grid pattern. In some embodiments, only a single image is captured. However, it may be beneficial to capture multiple images without significantly increasing cycle time.

Systems herein can be mounted to an end effector, and more easily maneuvered around a surface to obtain surface topography information. It is noted that embodiments using a single grid pattern, and obtaining a single image, results in sacrificed resolution in the Z direction (e.g. how deep the defect extends into the surface or how far it extends above the surface). However, it is only important for some embodiments, to identify a defect location, determine whether it is above or below a clearcoat layer, and estimate the height.—In some embodiments the inclusion of one or more additional cameras, positioned at alternate angles/positions, could improve depth detection by using multiple cameras.

The different structured light patterns illustrated in FIG. 8 are presented as examples only, and not intended to be limiting. For example, while pattern 802 illustrates vertical lines, it is expressly contemplated that horizontal or angled lines may also be used. Additionally, pattern 804 illustrates alternating sized grid patterns, however it is expressly contemplated that a single size grid pattern could also be used. Images 806 and 808 illustrate different patterns that involve circular apertures. Patterns 802-808 are provided by a patterned lighting device. However, it is expressly contemplated that other grid aperture shapes and sizes are also possible. Additionally, dynamically changing light patterns, e.g. deflectometry, single shot deflectometry, etc. may also be used.

Camera systems have a number of variables that can be adjusted to capture different information about a surface—gain, aperture and exposure time, angle of acceptance (incoming angles/vectors that can be mapped to a pixel), angular field of view, as well as numerous other settings. For example, increasing gain may increase a signal to noise ratio for haze on a surface. Some embodiments herein, then, may shift the gain multiple times, capturing multiple images. Comparison of the different images taken at different gains facilitates the enhancement of the measurement of haze. Haze can be a combination of signal and noise and, therefore, variation in a set of captured images taken at different gains, may help identify and quantify haze. Gain, and / or light intensity, may also be adjusted based on a color of a base coat of paint.

While other suitable light sources may be used, some systems and methods herein utilize any LED lighting systems at a range of intensities. The conditions of imaging may include a high frequency and small aperture on a camera's lens to provide a large depth of field require LEDs. High intensity LEDs may be particularly useful for specular surfaces, which do not diffuse light and reflect most light in a single direction. High intensity LEDs increase the probability of capturing defect information, given a certain exposure time, as increasing the amount of incoming light increases the amount of light captured. While, generally, exposure time increases for small apertures, a high intensity light can compensate, allowing for a reduced time needed to capture each image required. Systems and methods herein use static structured light to identify clearcoat defects, and scattered light to identify optical haze in the clearcoat.

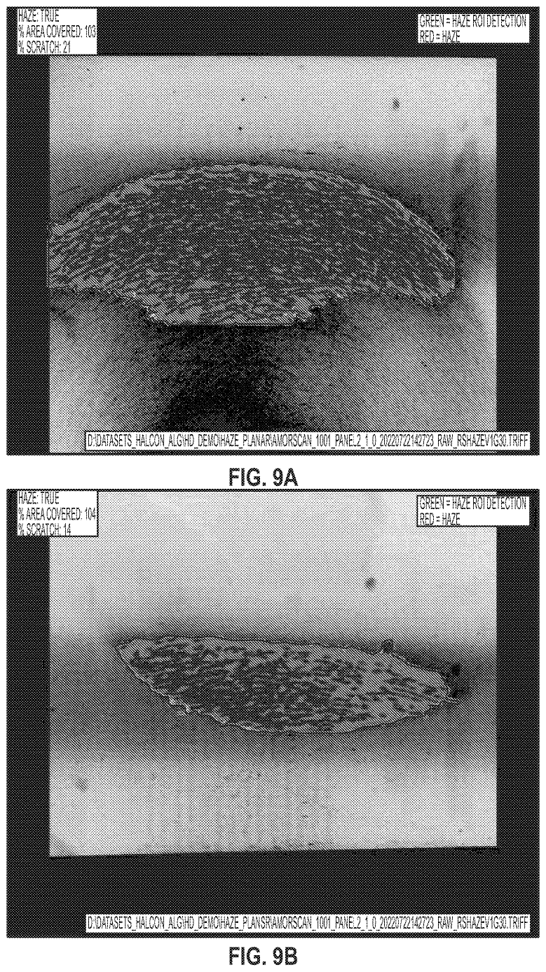

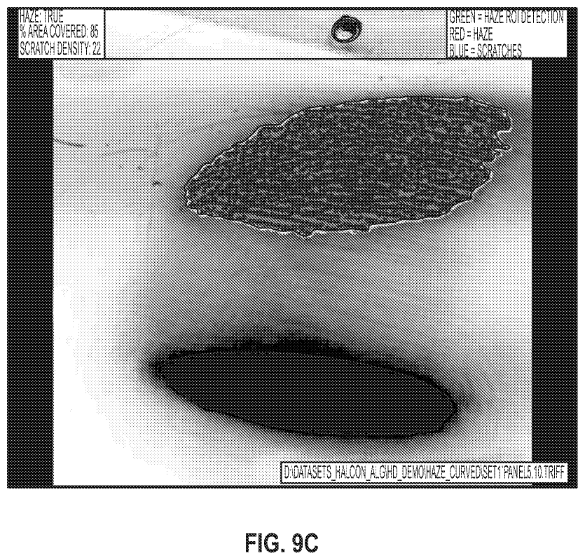

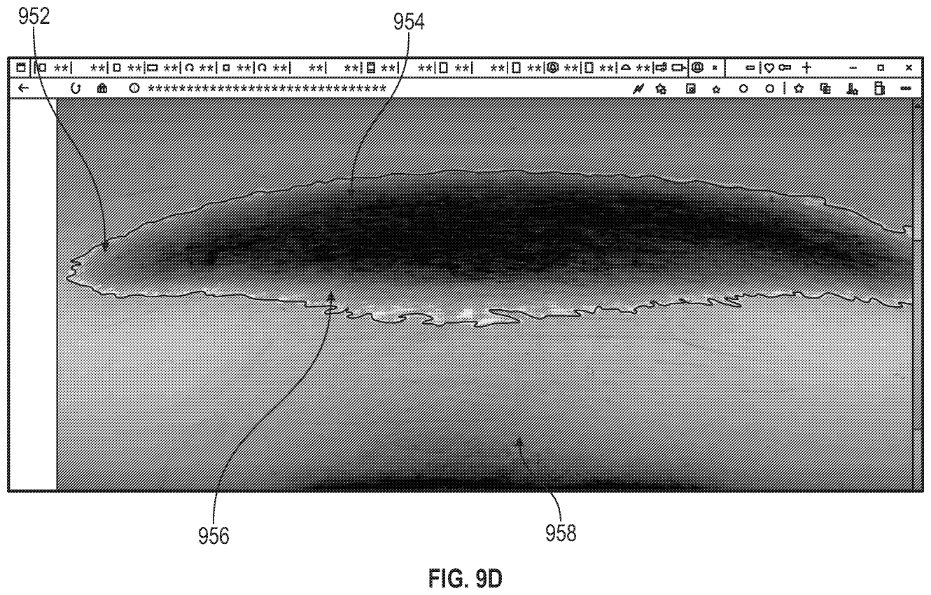

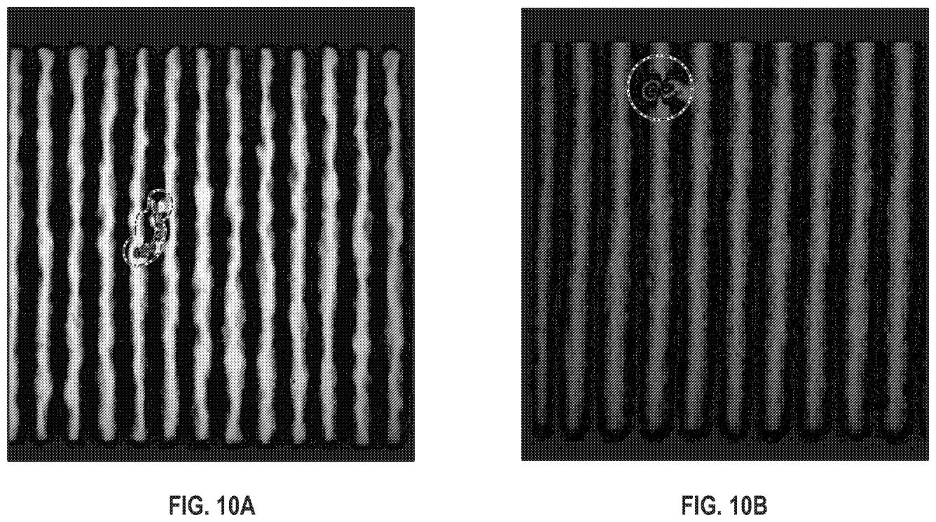

FIGS. 9-10 illustrate the results of images captured using systems herein and processed using systems and methods described herein. FIGS. 9A-9C illustrate the results of processing images to detect haze on the surface. FIGS. 9A-9C illustrate a curved surface of a motorcycle fuel tank curve within the specular reflection splotch. Illustrated particularly clearly in As processed, the images of FIGS. 9A-D provide surface issues and defects that in an objective and quantifiable manner Haze can be quantified, by determining a scratch density for a given area of haze. Using systems and methods herein, it is possible to have the system automatically identify an area of haze, determine a density of the scratches within that haze area, and calculate a percent haze that a human eye might perceive. The calculation may be done in any suitable manner, for example using a segmentation algorithm, a machine learning based algorithm, or another suitable algorithm. The images of FIGS. 9A-9C are post repair inspection images, captured of after surface modification operation has been completed. In some embodiments, images like those of FIGS. 9A-9C may be presented to a user using a user interface. In other embodiments, a haze percent output is presented. In yet other embodiments, a satisfaction indication is provided, such as “repair successful” or “repair unsuccessful” or “second pass needed”.

FIG. 9D illustrates a processed image of a surface post-modification. An area of haze is present on the surface, outlined by outline 952. The density of micro scratches varies across the surface, with a high-density portion called out by arrow 954, and a low-density portion called out by arrow 956. Shadowing 958 is also visible on the processed image, which is partially due to artifact from the specular reflection of the light. In contrast, the region outlined by outline 952 is the back scatter region of the light. Micro scratch defects are best visible when using back scattering lighting systems. A high intensity line light at different angle of attack from that of the diffuse light panel, is used. The angle used for back scattering lighting is often referred to as a backscatter angle.

FIGS. 10A-10B illustrate the results of imaging for defect detection. A vertical line structured light pattern, such as that illustrated in FIG. 8, image 802 was used to image a surface. As illustrated, each image shows how defects become readily apparent using a static structured light process. As described above, with respect to FIG. 3, once a defect is detected within an image, it is possible to characterize the defect, for example type or severity or both. The images of FIGS. 10A-10B illustrate images captured of a surface that needs surface modification, in which a defect is detected. It is possible to see clearcoat defects with some amount of Z-deformation, either above or below the defect. Based on the shadowing effect and defect feature filtering illustrated in FIGS. 10A-10B , it is possible to use an image segmentation algorithm to detect whether or not the defect is above or below depth point in the clearcoat, and characterize a type and severity of the defect. However, while an image segmentation algorithm is used in some embodiments, it is also envisioned that other unsupervised algorithms, as well as trained machine learning algorithms, may be used in some embodiments.

Defect detection may be best detected using a collimated lighting system. Defects may have some three dimensionality (e.g. defect size, shape and / or location within a Z-axis of clearcoat layers), so it is important to see the shadowing effect of a defect within the layer of clearcoat. A specular lighting set up may consist of the light source and the camera being tilted so that the reflected light is received by the camera.

In some embodiments, a pre-scan of a surface, which provided initial location information of surface abnormalities, may be used to generate a surface modification trajectory. However, in some embodiments, the results of the specular imaging near where the defect repair will occur provide further information that can be used to either generate a surface modification strategy, or to modify the surface modification strategy selected previously.

It is expressly contemplated that lighting setups, including selected angles for a line light or an area light, as well as a structured light pattern, may all be selected at least in part based on the pre-scan of the surface. While it may be possible to conduct both a specular imaging process in addition to a backscatter process imaging process during a single imaging step, it is also contemplated that one imaging step occurs before the other. In such an embodiment, it is possible that information gleaned from the first imaging step is used to better inform settings for the second imaging step.

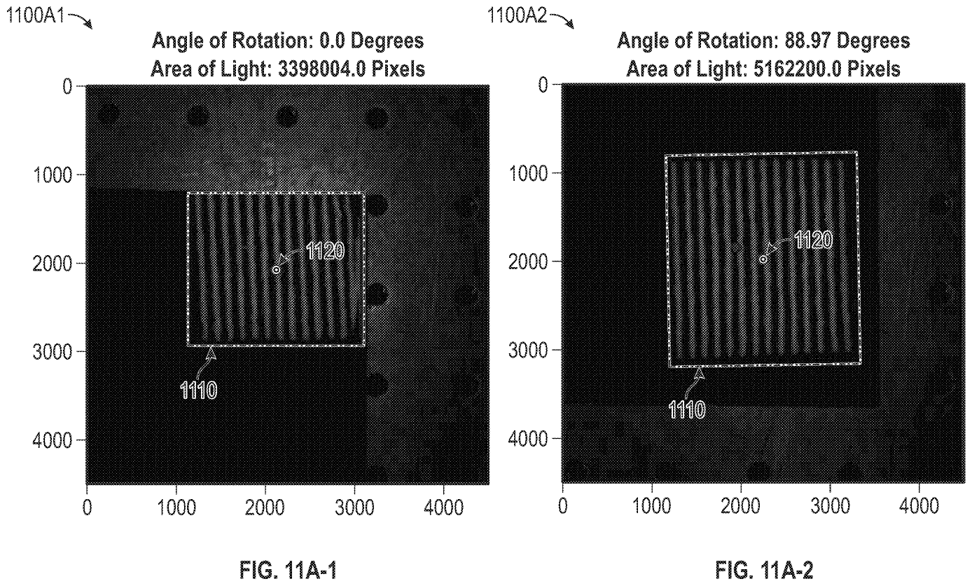

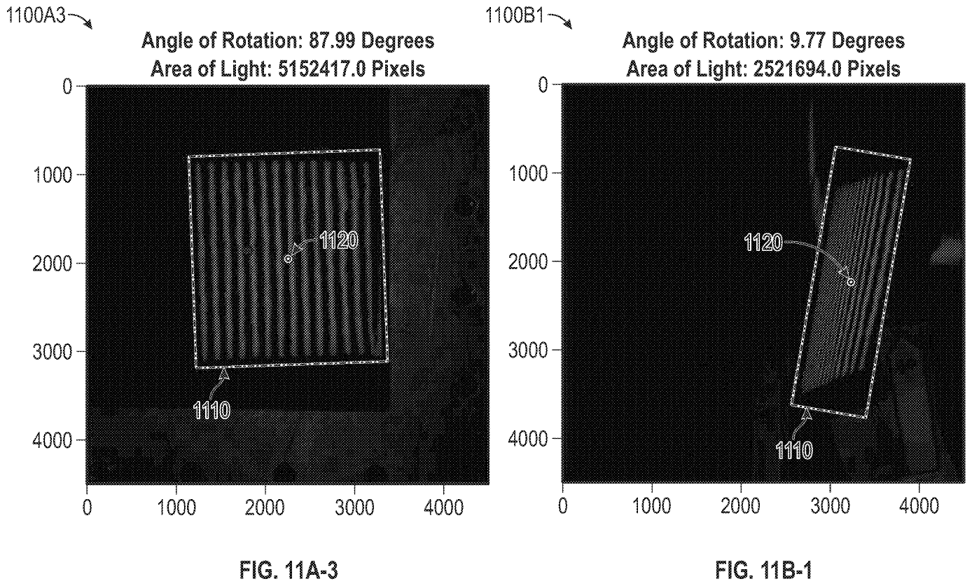

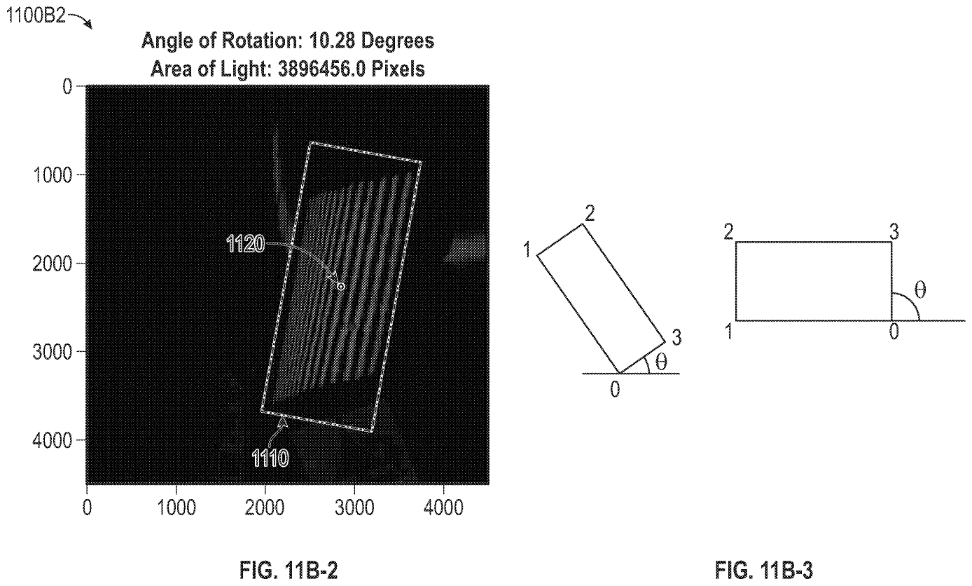

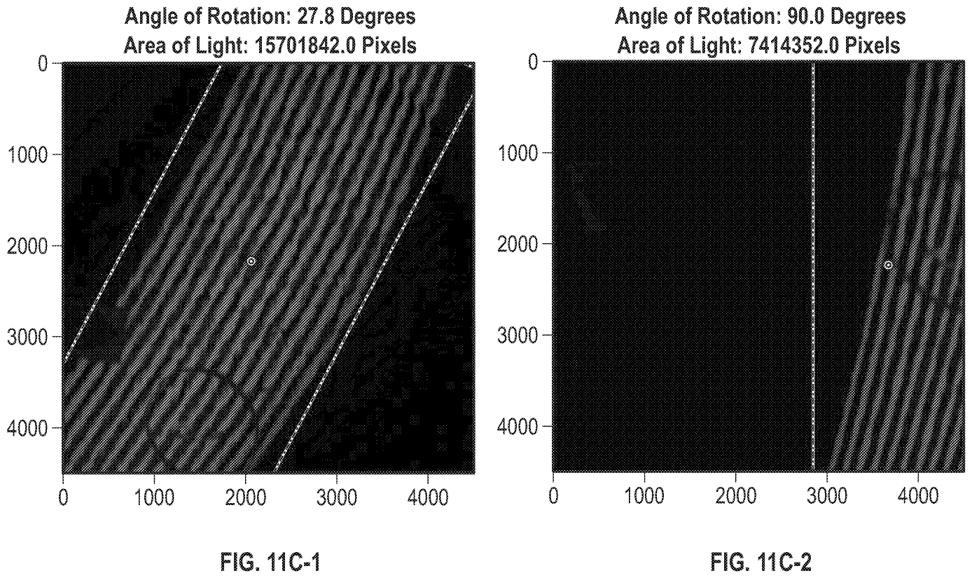

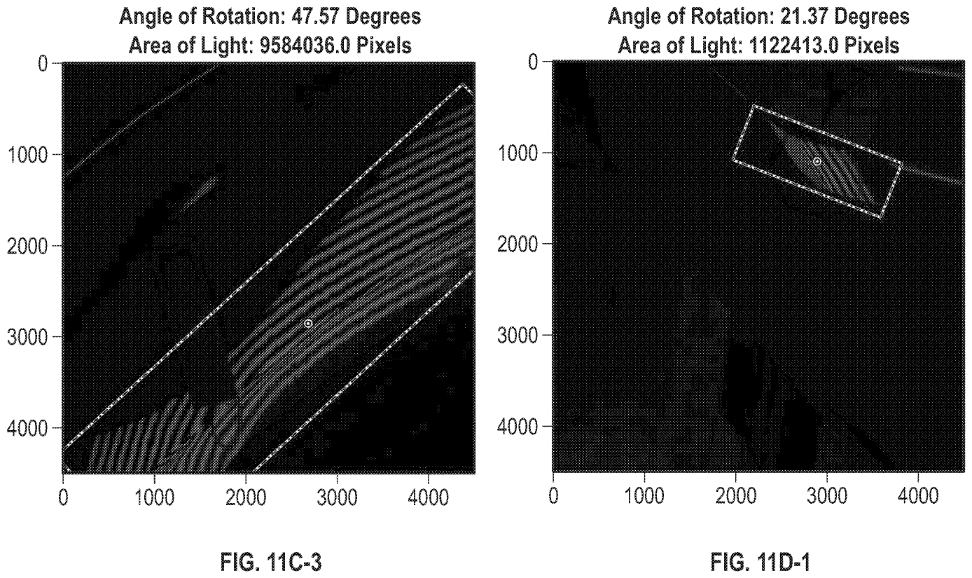

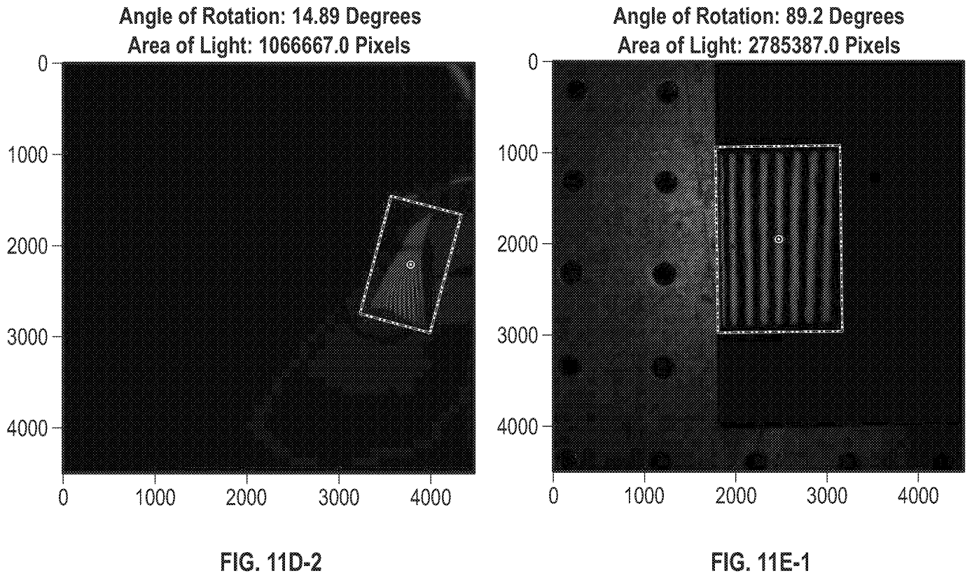

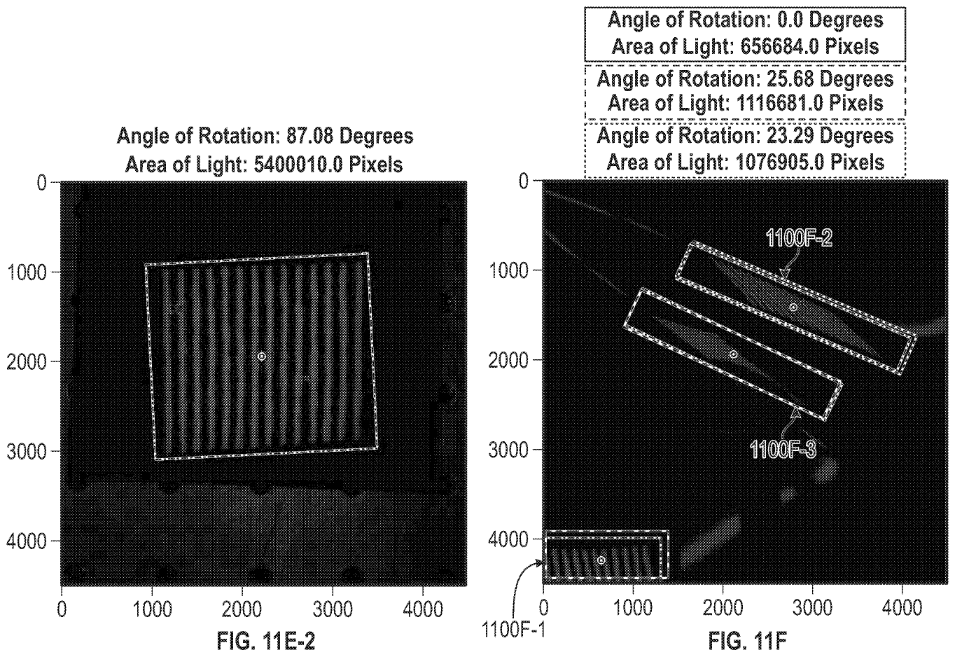

FIGS. 11A-F illustrate images of reflected gridded light on surfaces generated using systems and methods herein. FIGS. 7A-7F illustrate images of fringes on a surface. While the images of 7A-7F were captured using a flat light, it is expected that the light bars would shrink due to the morphology of the light as well as the shape of the surface being imaged. Because the light curvature is known, this can be accounted for. Projections are made with the assumption that only the surface imaged is changing. It is expected that a convex-shaped light source will cause shrinkage while a concave light will cause expansion.

Given a constant curvature, specific fringes are produced. When a surface has a region with high curvature change, reflections may be captured from several fringes, in some embodiments, or all fringes, in some embodiments.

Systems and methods herein may be useful for confirming whether a part is correctly positioned. For example, for a repair to a vehicle surface, the vehicle may experience jostling during a time from an initial imaging to a time of repair. Or, for a door repair, a standoff may be present between the door and the vehicle that shifts in position. Such changes could result in a repair being done to an incorrect portion of the surface, cause a collision between the repair machinery and the vehicle, etc.

Systems and methods herein may also be used to re-identify or relocate a defect position prior to a repair starting using an end-of-arm system. Confirming a defect is in the expected position, or identifying how the robotic repair system needs to adjust based on a new position can provide upstream information about an assembly, repair, or manufacturing system. Systems and methods herein can provide feedback about system tolerances. For example, if a defect movement is consistently within a threshold range, the tolerance is staying the same and a repair recipe and repair area size (for example selected previously during a repair process) may proceed. If instead it is seen that a tolerance is tighter than expected (e.g. a defect is within a smaller threshold range of the expected location), then the repair area may be reduced, allowing for a repair to proceed faster. If instead it is seen that a tolerance is slipping (e.g. a defect is outside the threshold range) then additional action needs to be taken to ensure that a planned repair is completed without requiring a re-repair. The additional action may involve increasing a repair area, moving positions of the repair robot, or selecting a new repair strategy.

Especially in areas of a surface where smaller repair areas are preferred, using systems and methods herein to confirm can reduce the likelihood of a re-repair needed and reduce the amount of time for repair by confirming position in-situ.

Using gridded light, images 1100A1-1100F of a reflective surface can be captured, as illustrated in FIGS. 11A-11F. Processing the images can result in a boundary 1100 being calculated, which is a minimum area that can capture the full light bar. The images can undergo image processing to produce two outputs: (1) an angle of rotation and (2) an area of the reflected light. Boundary 1100 may be defined by a center 1120.

From a previous imaging, or CAD model, of a vehicle (or other surface) being repaired, the process image can be used to verify whether the field of view in a boundary 1100 is as expected. Curvature on a surface causes light to reflect differently, in predictable ways.

Angles of rotation of 0, 90, 180, 270, etc. result in an upright rectangle boundary 1100. Square boundaries 1100 have C4 symmetry (rotations by 2π/4, e.g. 90°) and may result in indistinguishable shapes. Rectangular boundaries have C2 symmetry (rotations by 2π/2, e.g. 180°) and may result in boundary sides being aligned with “vertical” and “horizontal” axes.

FIG. 11A1-3 illustrate light reflections off of a flat panel, e.g. having no curvature. The orientation of the part with respect to the vision system can be verified by whether the angle of rotation is a member of the rectangular symmetry group (C2) In the examples, this present as +/− a threshold of 0, 90, 180, 270, etc. degrees.

Additionally, the location of a boundary 1100 can be further verified with the area in view, with respect to the expected area. For example, image 1100A1 has a portion of the light off the panel, thus not utilizing the entire possible field of view (FOV). This allows for feedback between the imaging system and location coordination.

An end-of-arm vision system also allows for images to be captured while the system is moving with respect to a surface. Images 1100B1 and 1100B2 were captured by an end of arm system in potion. Both an angle of light and the area within boundary 1120 change as the system moves along a curve. With knowledge of the expected curve (e.g. from CAD files, 3D scanning or previous imaging), the captured angles/light area of the expected region can be evaluated and deviations detected.

In general, the area of a boundary 1100 will expand as the vision system approaches normal orientation. The angle of the region of interest will similarly approach 0/90/180/270. In some embodiments, confirmation that a repair system is aligned with normal is done before imaging and repair of the defect.

The location can be further verified with the area of the light grid reflection visible with respect to the expected area. For example, the first image has a portion of the light off the panel, thus not utilizing the entire possible field of view (FOV). This number allows for feedback b/w the imaging system and location coordination.

FIGS. 11B-1 and 11-B2 illustrate images of reflected light on a curved surface, obtained using a gridded light. From images 1100B1 and 1100B2, curvature of the surface can be detected. A center point 1120 for each calculated boundary 1110 are illustrated. Image 1100B1 illustrates an image captured at an angle of rotation of 9.77° resulting in a bounded area of 2521694.0 pixels.

The angle of rotation is calculated as illustrated in FIG. 11B-3. After the rectangular boundary is identified, the 4 corners of the bounding rectangle points are ordered clockwise starting from the point with the highest y as shown below. If 2 points have the same highest y, then the rightmost point is the starting point. The points are numbered as 0,1,2,3(0 -starting, 3-end). The angle between the line (joining the starting and endpoint) and the horizontal is illustrated in FIG. 11B-3.

The angle of rotation is calculated as illustrated in FIG. 11B-3, and the area of the bounding rectangle is measured. The camera position and surface curvature information being already known, a determination can be made as to whether the system is aligned to the curved region, within acceptable tolerances. If the alignment is outside the acceptable tolerances, the transformation from 11B-1 to 11B-2 is made to provide a better reflection area in the FOV of the camera.

Image 1100B2 illustrates an image captured at an angle of rotation of 10.28 degrees from the surface, resulting in a bounded area of 3896456.0 pixels. Images 1100B1 and 1100B2 may be two images captured at different times in an image captured sequence. The observed change in boundary area and pattern of reflected light can be compared to that expected for a known surface. If the observed change does not match what is expected, then the imaging system is not in the expected location. For example, if the area is smaller than expected, this indicates higher convex-surface curvature than expected, while if the grid is only partially reflected, and instead lies off-screen, this might indicate that the alignment angle of the system is off.

Similarly, by observing the change in boundary area and pattern of reflected light, the curvature, or topography, of the imaged surface can be determined, such that it is possible to compare what is seen to, for example, a CAD model of the entire surface, to identify what position on the surface is being imaged.

FIGS. 11C-1 through 11C-3 illustrate an example of a concavity on a surface. An optical cone (also referred to as a viewing cone in some domains), with the cone start at the sensor and expanding downward, includes all rays of light that are received by the sensor (e.g. camera in some cases). The optical cone expands as the optical axis extends toward the surface being imaged, and continues to diverge when looking at the origins of those reflections. For a flat surface, with the camera and light placed at specular angles, a uniform squared reflection region is expected. As curvature of a surface increases, the number of reflected rays at the camera sensor increases or decreases, changing the shape of the reflected region. With this information, we can deduce the concavity and convexity of the look at region. The optical cone expands at a greater rate if the surface has convex curvature, resulting in a smaller reflection. The optical cone expands at a slower rate if the surface has concave curvature, resulting in a larger reflection.

Concave shapes cause the light to expand, and can have varying angles. If the area for the light in the region of interest is greater than the maximum area on a flat surface, a concave surface is indicated. FIG. 11C-1 illustrates an image captured at an angle of rotation of 27.8° and resulted in an observed boundary of 15701842.0 pixels. FIG. 11C-2 illustrates an image of the same surface captured at an angle of rotation of 90.0°, resulting in an observed boundary area of 7414352.0. FIG. 11C-3 illustrates an image of the same surface captured at an angle of 47.57°, resulting in an observed boundary of 9584036.0 pixels. As illustrated in FIGS. 11C-1 to 11C-3, which are all images of the same area, with small transformations (rotation, translation, etc.), the same surface results in different resulting images, with different centroid positions of the bounding rectangle, based on the light rays reflected to the camera.

FIG. 11D-1 and FIG. 11D-2 illustrate an example of a surface with convex curvature. Convex curvature causes light to contract, resulting in light in a region of interest to be smaller than a maximum area of the light region of interest on a flat surface, and typically at an angle that is not close to 0/90/180/270°. FIG. 11D-1 illustrates an image captured at an angle of rotation of 21.4° and an observed boundary area of 1122413.0 pixels. FIG. 11D-2 illustrates an image captured at an angle of rotation of 14.9° and an observed boundary area of 1066667.0 pixels.

FIGS. 11E-1 and 11E-2 illustrate images of a surface when the imaging system is approximately at normal. Flat, or substantially flat shapes will have an angle of rotation near to 0/90/180/270 and an observed area at or below the maximum light region of interest. FIG. 11E-1 illustrates an image of a surface captured close to 0/90/180/270.

The orientation of the part with respect to the vision system can be verified by whether the angle of rotation is a member of the rectangular symmetry group (C2) In the examples of FIGS. 11A-E, this present as +/− a threshold of 0, 90, 180, 270, etc. degrees.

FIG. 11F illustrates a scenario where, due to the geometry of the surface being imaged, multiple light regions of interest may be displayed in a single image. The angle can help identify relative curvature within the 2D image of FIG. 11F. Light region of interest 1100F-1, having an angle of 0° is approximately normal to the vision system, and can be estimated as a flat surface. Light regions of interest 1100F-2 and 1100F-3 have an angle of rotation not close to 0/90/180/270, so there likely greater relative curvature in this portion of the part. When compared to a 3D rendering, CAD model or other topography of a surface, a position of the imaging system can be validated.

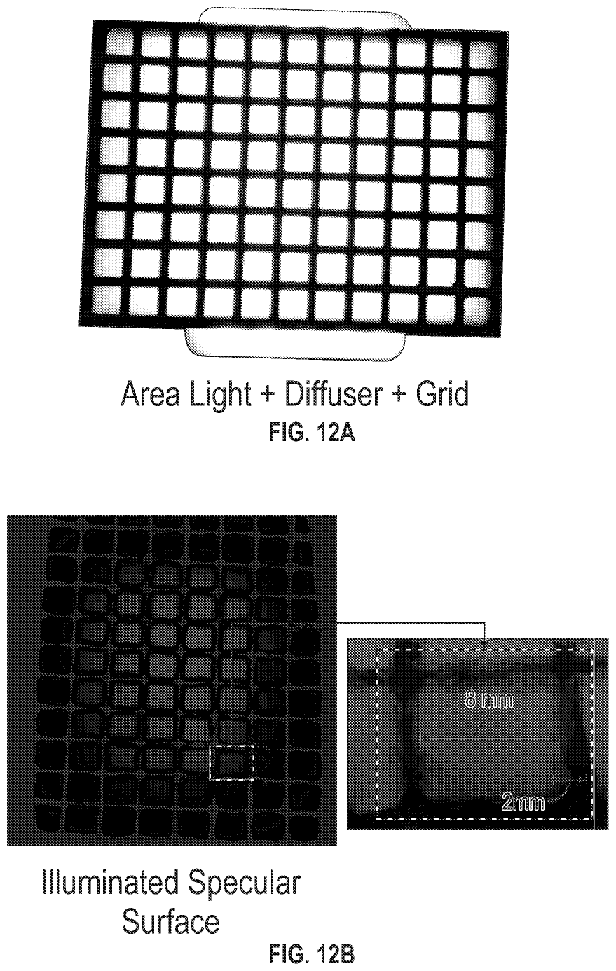

FIG. 12 illustrates a static structured light set up in accordance with an embodiment herein. As illustrated in FIG. 12A, an area light is mounted with a diffuser and a diffuser grid pattern. As illustrated, the diffuser grid pattern may be a simple grid. FIG. 12B illustrates an illuminated specular surface. As illustrated in FIG. 12B, the grid may consist of 8 mm squares. Even illumination is provided throughout the area of the light. The light, grid spacing, and/or pattern can differ based on a specific use case. The grid disrupts the diffuse light source, causing the light to hit defects in a directional manner, resulting in shadowing effects that can be used to characterize the defect. Therefore, it may be important to balance a width of grid lines and a width of grid spacing. If the grid is too wide, the defect will be lost in the blank space between grid lines. If the gridlines are too narrow, sufficient shadowing effects for characterization may not be produced.

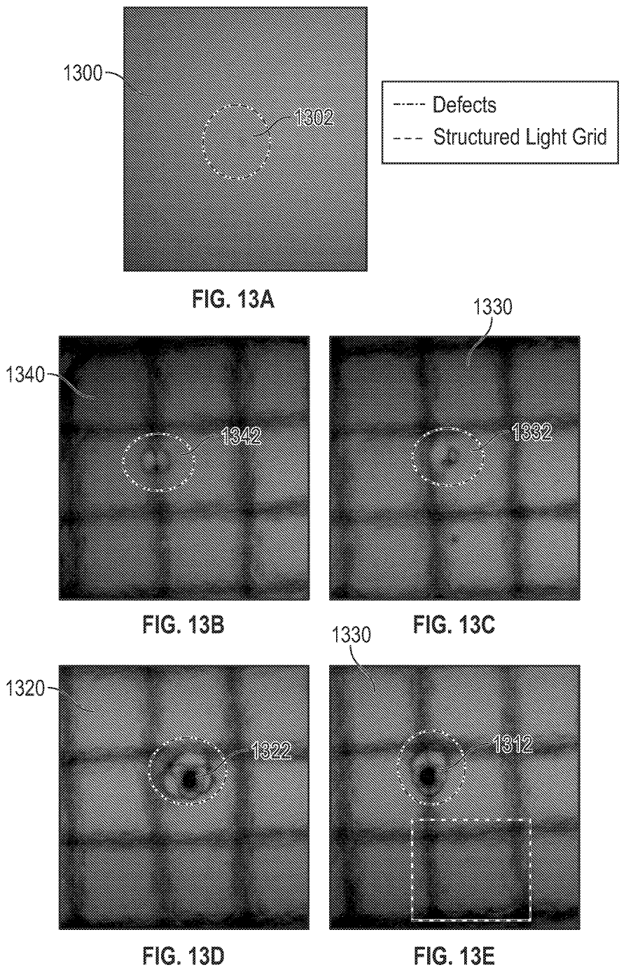

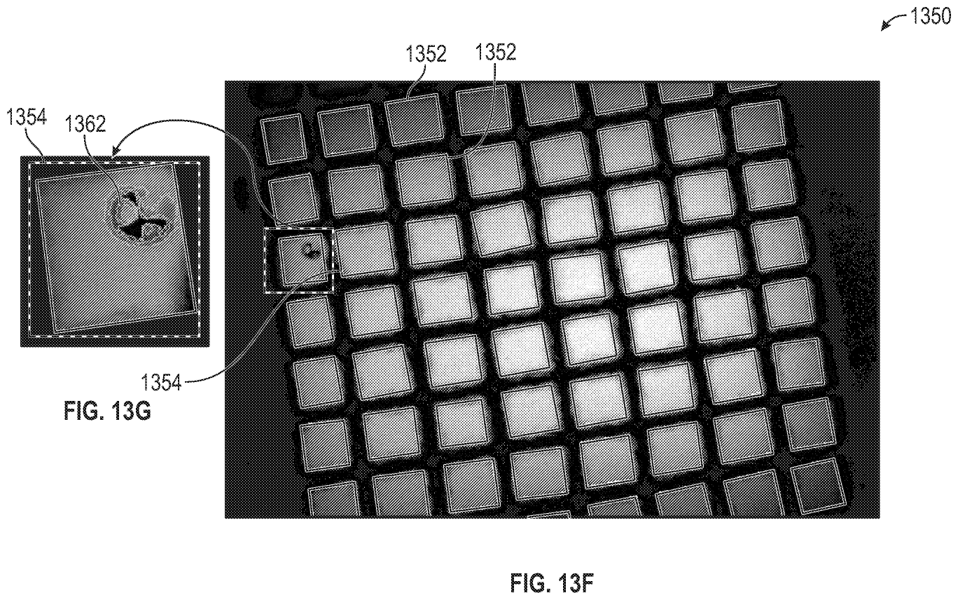

FIGS. 13A-13G illustrate images of a surface captured using static structured light with a grid structured light pattern. FIG. 13A illustrates a captured image 1200 of the surface without the structured light pattern. As seen in FIG. 13A, defect 1202 is small and difficult to detect using diffuse lighting techniques alone. FIG. 13B illustrates an image 1240 of a surface with a defect 1242. The defect 1242 happens to be aligned with one of the lines of the grid pattern. This allows for visible shadowing effects around defect 1242. The shadowing effects can be interpreted using a machine learning algorithm, for example, to identify a type of defect 1242, severity of the defect 1242 and an estimated height of defect 1242. FIG. 13C illustrates an image 1230 capturing defect 1232. Defect 1232 has some shadowing from the grid pattern, which can be extrapolated by a machine learning algorithm to characterize defect 1232. FIG. 13D illustrates an image 1220 of a defect 1222 with shadowing effects from the top and side of the grid nearest defect 1222. FIG. 13E illustrates a defect 1212 in an image 1210 that, similarly to defect 1242, has been captured with one line of the grid pattern overlapping the defect, providing good shadowing from which a machine learning algorithm can extrapolate characterization information. Some or all of the images illustrated in FIGS. 183B-13E may be used to characterize the defect.

In comparing FIG. 13A with FIGS. 13B-13E, it is shown that systems and methods herein provide quantifiable characterization information about a surface. Machine learning algorithms can be used to correlate the shadowing visible in the captured images to a size and/or depth of a trapped piece of debris. FIGS. 13B-13E happened to be sequential images captured from different angles of illumination of a single defect. Illumination from different angles provides more information for characterizing the defect. Having an image capturing system on an end of robot arm, which can be moved precisely through space allows for sufficient control to capture images of the defect from precise positions at multiple angles.

FIG. 13F illustrates an image 1250 of a surface containing a defect 1262, shown more clearly in FIG. 13G. In some embodiments, a machine learning algorithm is used to identify boundaries 1252of a structured light pattern used over a backlight. This may provide for more precise characterization of defect 1262. FIG. 13G illustrates a close-up view of a single grid 1254 containing defect 1262. Identification of a single grid square, or multiple grid squares, that contain part or all of the defect, can provide for more precise and efficient surface characterization. Knowing where the defect is within the grid structure, using an edge detection algorithm, allows for the domain of the image to be reduced. This may reduce cycle time further, by only processing the portion of the image that contains the defect. It may also reduce the noise detected.

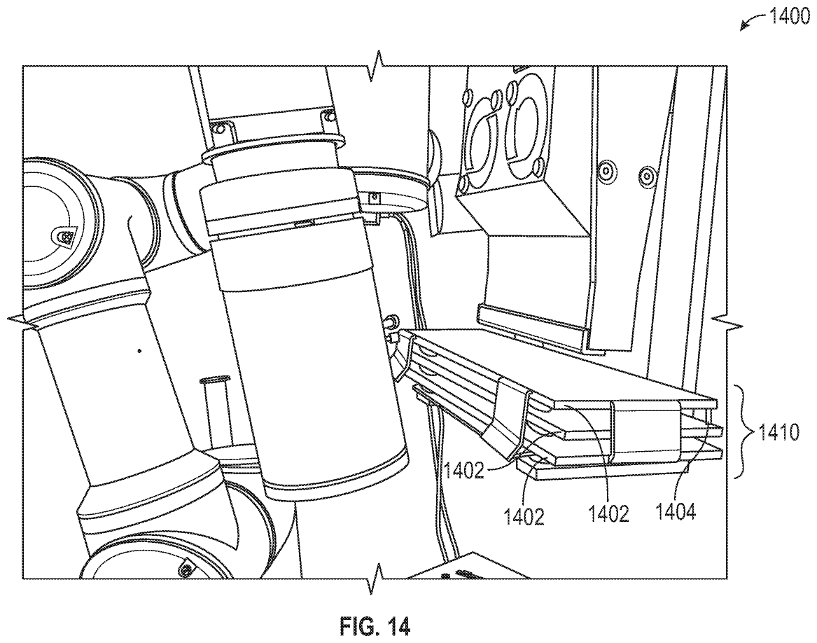

FIG. 14 illustrates a diffuser plate stack that may be used in some embodiments described herein. FIG. 14 illustrates a close-up image 1300 of an image capturing assembly. An image capturing device 1302 is positioned next at an angle to a high intensity line light 1354. A diffuser stack 1310 is placed in front of line light 1354. Illustrated in FIG. 14 is a stack 1310 of three diffuser plates 1302, with spacing 1304 between them. Diffuser plates 1302 spread the line light out, allowing for capture of an intensity profile along the axis perpendicular to the line light. This can be used, in some embodiments, to transform the line light into an area light. However, diffuser plates 1302 may also be used to provide a gradient of lights that illuminate a defect as if the light was coming from a single direction or a light source at a shallower angle. Spacing 1304 may be the same, or different, between adjacent plates 1302.

FIG. 14 illustrates an embodiment where a diffuser stack 1310 comprises three diffuser plates 1302. However, it is expressly contemplated that more, or fewer, plates 1302 may be used in other embodiments. For example a single diffuser plate 1302 spaced away from line light 1354 may be sufficient for some applications. A stack of two diffuser plates 1302 may be useful in other applications. More than three diffuser plates 1302, such as four, five, six, or more, may be useful for yet other applications.

While some embodiments of a diffuser plate stack are illustrated and described herein, it is expressly contemplated that a number of diffuser plates, and configurations, are possible. For example, diffuser plates are available along a range of haze transmissivity, clarity, and thickness. Many diffuser plate constructions may be suitable for embodiments herein.

In some embodiments, the one or more diffuser plates 1302 may be movable within the system 1300, such that one or more plates 1302 can be moved into, and out of the way of the light projected by the line light. Additionally, it may be possible to move the plates 1302 with respect to each other, increasing or decreasing spacing 1304, or with respect to the line light, moving them closer to or further away from the line light. This may be accomplished, for example using a slide system such that a robotic controller can actuate the slide to move the one or more plates 1302 into or out of position.

It is envisioned, that light sources and embodiments herein may be turned on or off as needed by a robotic controller. However, it is contemplated that heat may be generated during the process, which may need to be removed from the system. One or more sheet management options may be implemented, for example a fan, a conductive material, insulation, coolant, or another suitable heat management option.

The use of diffuser plates within a stack provides a diffuse lighting environment without the need for a specific or specialty diffuser or other optical element built into an area backlight. Thus, it can alter an existing non-diffuse lighting scenario to provide relatively even and spread illumination when needed. It may also be useful to increase the illuminated portion of the field of view of the image capturing device. An increase in gap distance between diffuser plates increases the amount of impact that the diffuser plates closer to the light source have in spreading the light before the next diffuser. A diffuser plate takes collimated light from a light source and spreads out the angles-will spread the light further out onto the surface as it gets there. Spacing between diffuser plates in a diffuser plate stack changes the amount of diffusion that occurs. A larger gap between a first plate (closer to the light source) and a second plate (closer to the surface than the first plate) will cause light diffused by the first plate to hit the second plate with a higher profile.

Particularly in the context of imaging reflective surfaces, often a dedicated light source is needed to overwhelm ambient light intensity, or ambient light characteristics. For example, working with LED or other light sources, it may be useful to have diffusers that can spread light evenly across a field of view of an image capturing device. A structured light bar and diffuser plates may be able to create a diffuse lighting environment without specialty diffuser plates or other suitable optical elements. Additionally, in some embodiments this may allow for a mounted imaging system, such as that illustrated in FIGS. 7A-7B, to be even more compact on an end of robot arm, increasing maneuverability for a surface modification tool also mounted to the end-of-arm.

FIGS. 6-7 illustrated embodiments having a light source offset from a camera. However, it is expressly contemplated that other configurations are possible. Some currently available systems rely on a projection system, which requires a high-cost screen (e.g. LCD/LED) having high lumens, to project an adjustable reflection on a surface. Such systems also can require multiple cameras, and result in a computationally expensive analysis of the reflections—e.g. image stitching requirements, etc.. Embodiments herein can achieve similar analysis with smaller light panels and fewer cameras. End-of-arm systems described herein have greater maneuverability, enabling a smaller relevant field of view, which reduces computational analysis as well.

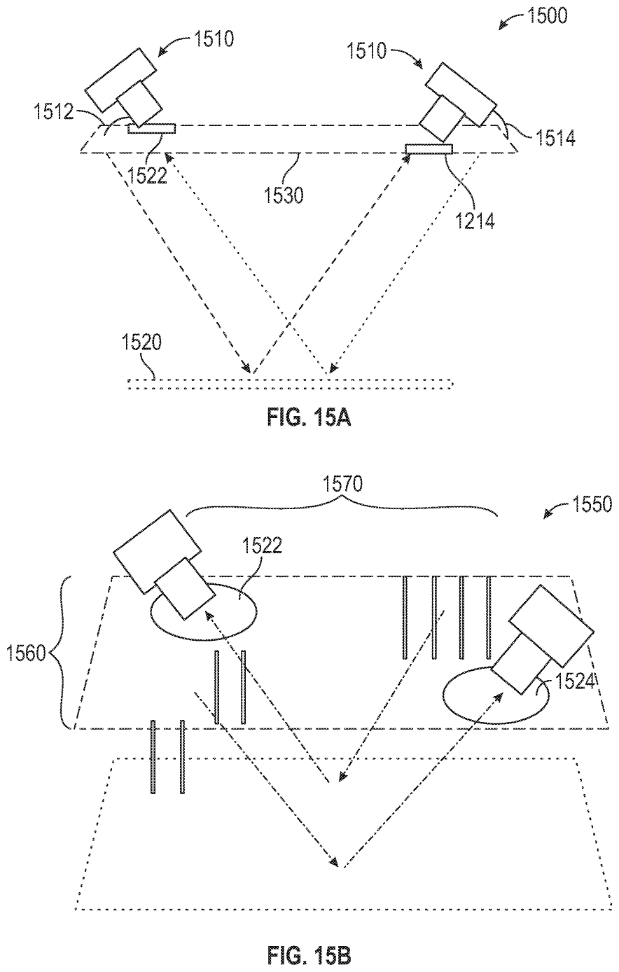

Systems illustrated in FIGS. 15-18 enable a smaller mechanical ‘footprint’ for an end of arm system because additional space is not needed for the light panel as cameras, instead, capture images through the light panel. Embodiments illustrated in FIGS. 15-18 also enable positioning of cameras at more acute angles from normal (with respect to the surface being imaged), which also reduces an overall system length. Systems and methods herein may also take advantage of specialized lenses, such as folded optics or thinner lens stacks to reduce an overall length, width and height of an end-of-arm vision system. Each of the embodiments presented and discussed in FIGS. 15-18 benefit from a reduction in space needed for an end-of-arm vision system.

FIGS. 15A and 15B illustrate a schematic of a surface imaging system 1500 in accordance with embodiments herein. Imaging system 1500 includes at least two cameras 1510 that image a specular surface 1520 through a light panel 1530. Light panel 1530 may be a gridded light panel, or another suitable light system. Each camera may be angled with respect to surface 1520, as illustrated by angles 1512 and 1514. Angles 1512 and 1514 may be similar, or even identical, in some embodiments. Each camera images surface 1520 through an area, e.g. areas 1522, 1524 of light panel 1530. Aras 1522, 1524 may include apertures extending partway, or completely through, light source 1530. FIG. 15A illustrates a side view of system 1500. FIG. 15B illustrates a dimetric view 1550 of system 1500, illustrating relative placement of cameras 1510. Cameras are placed apart from one another, for example along a length 1570 and a width 1560 of light source 1530. In some embodiments, cameras 1510 are placed in opposing corners of a panel light 1530. System 1500 is designed to image a specular surface with a reduced likelihood of holes in the grid reflection, e.g. an increased likelihood that the panel has no areas that are not illuminated by the light 1530.

The ability to reduce a volume occupied by a system 1500 is limited by the dimensions of light source 1530. Some applications require a larger light source, while others can use a smaller light source. Using system 1500, a width of a scanned image is expanded, while ambient lighting effects are reduced. A length of a scanned image is defined as the dimension of the reflection within the primary plane. A width is defined as perpendicular to the length. For example, industry applications currently use light sources on the order of a meter squared, while systems herein can utilize much smaller light sources, on the order of centimeters. The smaller size may enable systems herein to function on an end-of-arm system with a reduced risk of collision with the surface or other robotic components.

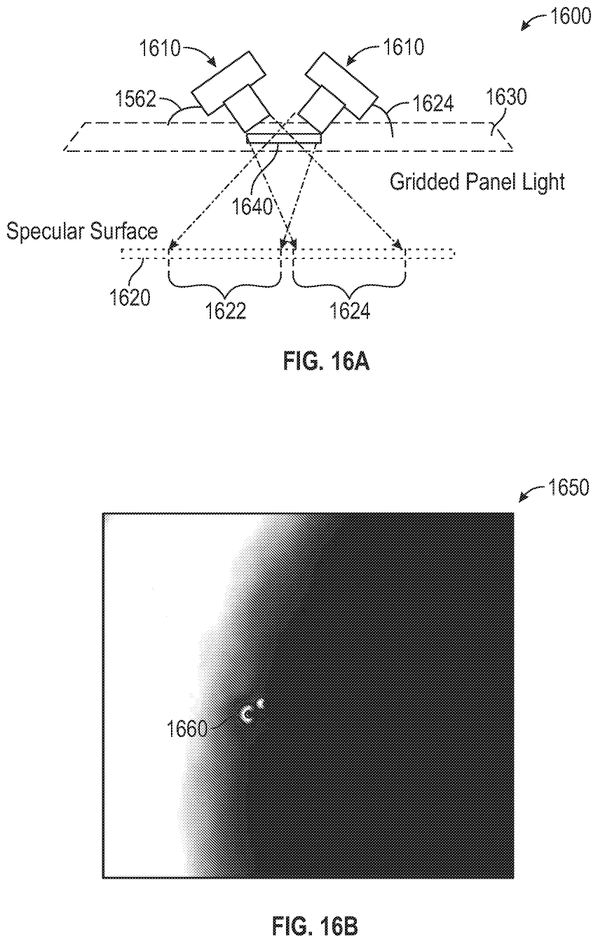

FIGS. 16A-16B illustrate a schematic of an outward facing surface imaging system in accordance with embodiments herein. System 1600 includes two or more cameras 1610 that image a specular surface 1620 through a light panel 1630. Cameras 1610 are positioned, and angled, to look through an area 1640 of the light panel. Cameras 1610 are positioned such that they look in opposite directions. Area 1640 may include, or be defined by, an aperture in light source 1630. Cameras 1610 are positioned such that a first field of view 1622, from a camera at an angle 1562, does not overlap with a second field of view 1624, from a camera at an angle 1562. It is noted that, while two cameras 1610 are illustrated, embodiments herein also envision a four-camera arrangement, with each camera separated by about 90° from adjacent cameras.

System 1600 increases an imaged reflection's physical size along the length dimension, fully utilizing the length of the light source. Because cameras 1600 are not imaging the same area, an overall field of view is increased.

However, because cameras 1600 are angled to increase a field of view, it is possible that an area directly underneath the viewing hole is not directly illuminated. As illustrated in FIG. 16B, this may result in a defect 1660 be illuminated in an image 1650 by diffuse light.

In some embodiments, a size of a field of view is reduced so that fields of view 1622 and 1624 overlap, or are positioned such that no, or substantially no gap, is present. In some embodiments, light source 1630 is fully, or substantially transparent such that surface 1620 can be viewed clearly through the light source 1630. In some embodiments, the light source projects light downward, toward surface 1620 such that there are substantially no shadowed areas on the surface. In some embodiments, light source 1630 projects light downwards evenly, such that there are few, or substantially no light patterns on the surface.

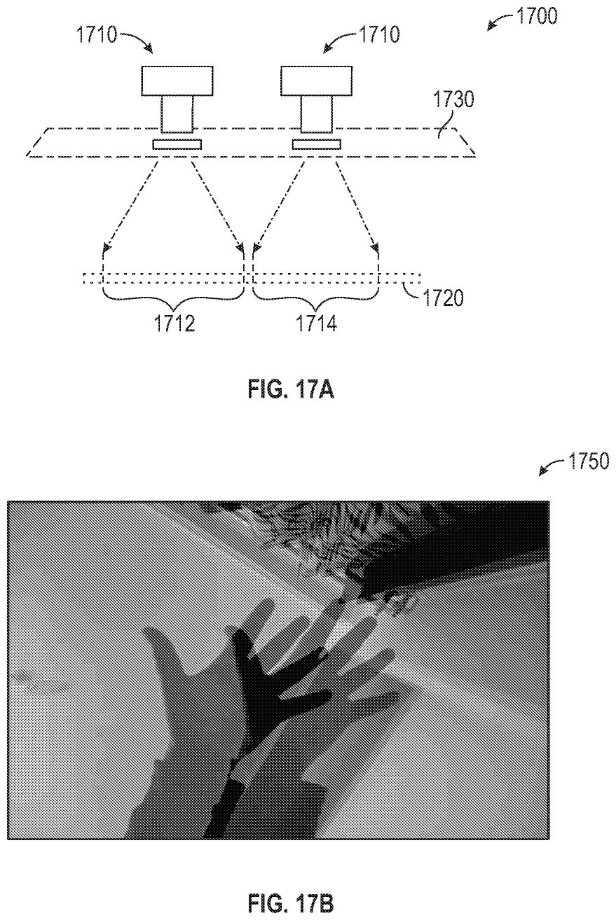

FIGS. 17A-17B illustrate a schematic of a binocular normal facing surface imaging system in accordance with embodiments herein. System 1700 operates similar to human vision, with two cameras 1710, spaced apart, each imaging a portion of surface 1720 through a light source 1730. Knowing relative positions of each camera 1710, the contrast between the two images (as illustrated by image 1750, for example) can provide depth information. Additionally, using a binocular view, images captured of surface 1720 are more likely to replicate how a surface defect would appear to a consumer. Cameras 1710 may image through light source 1730, through an aperture extending partway through, or through an aperture extending completely through light source 1730.

It is noted that, in some embodiments, cameras 1710 are placed with a straight coaxial view downward. In some embodiments, one of cameras 1710 is positioned to view surface 1720 through an aperture in the center of light source 1730.

FIG. 17B illustrates an example stereo image, computationally composed of two images captured from different places, which is useful for recovering 3D topography information.

System 1700 may, based on a distance between cameras 1710 and/or a distance between each camera 1710 and surface 1720, result in an area of surface 1720 between fields of view 1712 and 1714 that is either not imaged or not fully illuminated. However, in some embodiments, system 1700 includes a third camera 1710 e.g. such that cameras 1710 form a triangle.

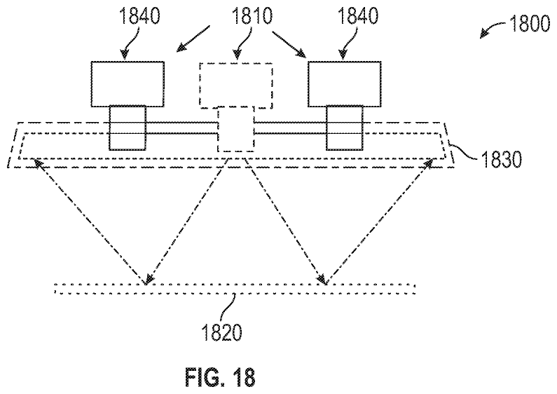

FIG. 18 illustrates a schematic of a light scattering surface imaging system in accordance with embodiments herein. System 1800 utilizes directional lighting technology to illuminate surface 1820. Light source 1830 includes a panel with a plurality of light sources that send light through the panel. The light is then projected downwards toward surface 1820. Light source 1830 may be a flat dome light, which may include one or more light sources on an edge of light source 1830 (e.g. such that light is projected through the transparent panel). The panel may also include one or more features to cause light to be projected through the panel and downward to the surface. For example, a number of concave or convex surface features may be present on the panel. In some embodiments herein, light is projected downward to the surface, but is returned from the surface. For example, an LFX3-PT Series light source, available from CCS INC. may be used in some embodiments herein. Light source 1830 provides the diffuse effect of dome lights with the on-axis illumination effect of coaxial lights by using a light-guide plate with features that project light downward toward a surface, but not upward toward a camera.

FIG. 18 illustrates a system including two cameras 1840 spaced apart from each other. However, it is expressly contemplated that additional cameras, such as camera 1810, may also be added without significantly increasing a footprint of an end-of-arm system. System 1800 allows for cameras 1840 to be positioned to view surface 1820 at a position normal to surface 1820. Additionally, t he part of the surface 1820 that is not specularly illuminated may be further illuminated by a dark field illumination technique. Additionally, while the system may need to be aligned to the defect normal, camera(s) 1810 may not be in-line with the defect normal.

System 1800 provides additional flexibility in that, since permanent apertures are not required in a light source, additional cameras (e.g. camera 1810) may be added or removed without disrupting the reflected image captured by existing cameras 1840.

However, while system 1800 is illustrated using a configuration similar to that of system 1700, it is expressly contemplated that a transparent light scattering light source 1830 could be incorporated into any of systems 1500, 1600 or 1700, for example replacing any of light sources 1530, 1630, or 1730.

Systems 1500-1800 may allow for decreasing a size of a specular inspection system by stacking cameras over a light source, such that cameras look through the light source. It is possible, using systems herein, to increase or maintain the size of the reflected image of the light source. While it has been discussed that some systems herein may have an area of diffuse lighting, or a hole in the reflected grid, it may be possible to reduce such interruptions by precise placement of cameras. Systems herein allow for a reduced overall size of an imaging system by rearranging the configuration of components—e.g. removing the need for placing a light source in the same plane as one or more cameras. Instead, the light source is nonplanar with the one or more cameras, such that a footprint (e.g. planar area) of the system is reduced. Stacking equipment reduces the overall volume of the system, allowing for larger effective fields of view, reduced image requirement for high curvature surfaces and, therefore, reducing inspection cycle time. Systems herein may be useful for detecting defects in a clearcoat layer of specular automobile surfaces, for example. However, it is expressly contemplated that systems herein may be useful for other specular surface imaging operations.

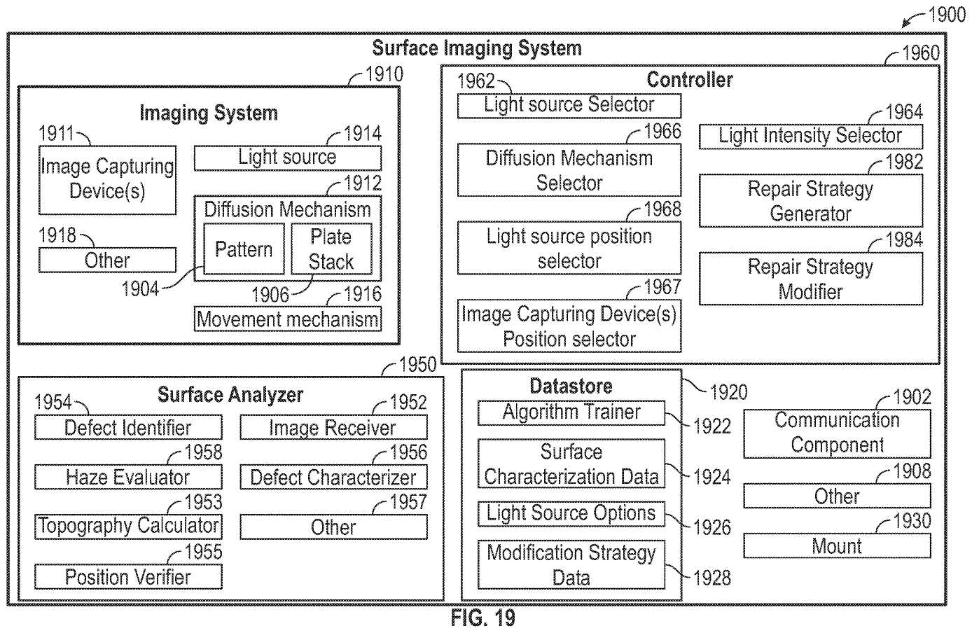

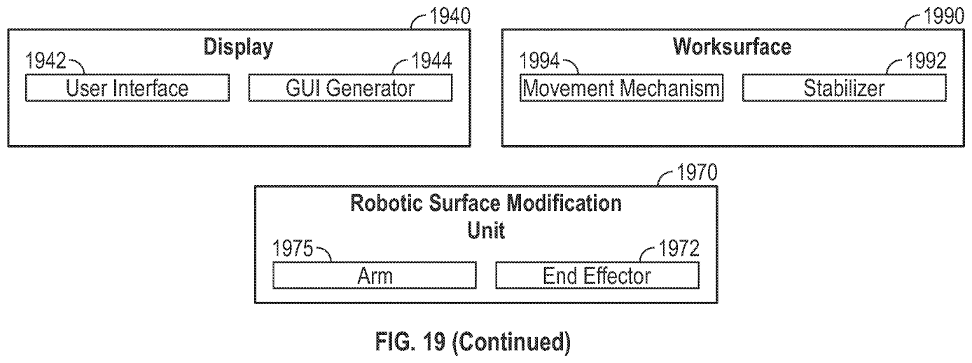

FIG. 19 illustrates a schematic of a surface imaging system 1900. System 1900 may be designed such that it can mount, using mount 1930, to a robotic surface modification unit 1970. For example, robotic surface modification unit 1970 may include an end effector 1972 that receives mount 1930. End effector 1972 may be on an end of a robotic arm 1975.

Surface imaging system 1900 includes an imaging system 1910. Imaging system 1410 includes one or more image capturing devices 1911, which may be cameras, video cameras, or other suitable imaging devices. Imaging system 1910 may have one or more light sources 1914, for example an area backlight used for light scattering, a line light used for specular imaging, a panel light, or a flat dome light. However, it is expressly contemplated that, in some embodiments, a single light source 1914 is sufficient.

Light source 1914, in some embodiments, is at least partially coplanar with the one or more image capturing devices 1910. However, in some embodiments, light source 1914 is not coplanar with the one or more image capturing devices 1910, such that light source 1914 is positioned in between an image capturing device 1911 and a surface 1990. In some embodiments, image capturing device 1911 images a system through light source 1914. Light source 1914 may have an aperture through with image capturing device 1911 views a surface. However, it is expressly contemplated that, in some embodiments, light source 1914 is transparent enough for image capturing device 1911 to capture images through light source 1914 without significant distortion.

Imaging system 1910 is illustrated as having a movement mechanism 1916. Movement mechanism 1916 may be responsible for changing an angle of image capturing device 1910 relative to light sources 1914, by adjusting an angle of one of image capturing device 1911, or light source 1914. Movement mechanism 1916 may also, in some embodiments, be configured to move one or more image capturing devices 1911 into position with respect to each other and/or light source 1914. For example, a system 1900 may be able to change between configurations in-situ, or between surface imaging operations, e.g. while moving from a first defect site to a second defect site. System 1900 may be able to adjust a position and/or orientation of imaging devices 1910 with respect to each other, or with respect to a light source 1914.

Movement mechanism 1916 may also be responsible, and some embodiments, for adding, removing, or changing a diffusion mechanism 1912. A diffusion mechanism 1912 may include a pattern 1904 provided to a light source 1914, to provide for structured lighting of work surface 1990. Diffusion mechanism 1912 may also, or alternatively, include a stack 1906 of diffuser plates. The stack 1906 may include a single plate, two plates separated by a space, or more than two plates, separated by equal, or varied spacing. There may be as many as three, four, five, six or more plates in stack 1906. Other components 1918 may be included in imaging system 1910.

Surface imaging system 1900 is illustrated as including a controller. However, it is expressly contemplated that controller 1960 may be located elsewhere within a robotic surface modification unit 1910, for example combined into a controller for modification unit 1970, and/or, remote from either system 1900 or robotic surface modification unit 1970. Controller 1960 includes a light source selector 1962 which may select whether a first light source 1914, a second light source 1914, or both light sources be on, or off, for a particular operation. For each of the selected light source, a light intensity selector 1464 may adjust an intensity of emitted light.

Controller 1960 may also include an image capturing device position selector 1967. Movement mechanism 1916 may receive a position indication from position selector 1967, which may include a physical position and/or an orientation for one or more image capturing devices 1911.

Controller 1960 may also include a diffusion mechanism selector 1966. In some embodiments, selector 1966 is able to select one pattern 1904 from a number of available patterns that can be placed in front of a backlight. However, it is expressly contemplated that a single pattern 1904 may be used for the entirety of a surface modification operation, so no change is needed. Diffusion mechanism selector 1966, in other embodiments, may select a pattern 1904 from a number of patterns, and place it between light source 1914 and work surface 1990. Alternatively, or additionally, diffusion mechanism selector 1966 may adjust placement of one or more diffusion plates within plates stack 1906, for example removing all plates, or placing one or more plates in between light source 1914 and work surface 1990. Diffusion mechanism selector 1966 may, for example, instruct movement mechanism 1916 to adjust a position of one or more plates in plates stack 1906, for example increasing or decreasing a spacing between plates, increasing or decreasing spacing between plates stack 1906 and light source 1914, etc. Based on feedback from a surface analyzer 1950, controller 1960 may generate a repair strategy to address a detected defect, for example using repair strategy generator 1982. However, it is expressly contemplated that a repair strategy may have already been generated based on a pre-scan of the entirety of work surface 1990, in which case a repair strategy modifier 1984 may be utilized to modify the repair strategy based on information gained from surface analyzer 1950.

Surface analyzer 1950 may retrieve one or more captured images, using image receiver 1952. Surface analyzer 1950, for example powered by one or more statistical image processing and feature detection algorithms trained by algorithm trainer 1922, for example, may detect a defect on work surface 1990, using defect identifier 1954. A defect characterizer 1956 may determine other information about a detected defect using the captured images, for example: a defect type, a defect size, a defect location on work surface 1990, a defect location within a clearcoat layer on surface 1990, an estimated defect severity, or other pertinent information. If imaging system 1910 has captured images of work surface 1990 after a repair has been completed, a haze evaluator 1980 may process the images to characterize an amount of haze on the surface 1990. Surface analyzer 1950 may also have other functionality 1957.

Surface analyzer 1950 may also include a position verifier 1955 which may verify a position of imaging system 1910 with respect to worksurface 1990. Images may be retrieved by image receiver 1452. From the retrieved images, topography calculator 1953 may calculate a curvature of the imaged area. Position verifier 1955 may then compare a curvature at a current position with surface characterization data 1924 to confirm whether imaging system 1910 and/or surface modification unit 1970 are correctly positioned for a surface modification operation. Calculated topographies and/or position verification information may be stored in datastore 1920. Over time, surface analyzer 1950 may monitor a drift over time-e.g. whether imaging system 1910 and/or surface modification unit 1970 are consistently in a correct position over a series of surface modification operations, drifting closer to being in a correct position, or drifting further from a correct position. Based on trends, a repair strategy generator 1982 may adjust a repair strategy to reflect a need to adjust a starting position for a repair operation.

Surface imaging system 1900 is illustrated in FIG. 19 as including a data store 1920. However, it is expressly contemplated that data store 1920 may be removed from surface imaging system 1900 and accessed, for example, using communication component 1902. Data store 1920 may include an algorithm trainer 1922 that is responsible for modifying a machine learning algorithm to improve defect characterization, by defect characterizer 1956, and/or haze quantification, for example by haze evaluator 1958. One or more algorithm trainer's 1922 may also be stored in data store 1924 repair strategy generation, by repair strategy generator 1982, or repair strategy modification, by repair strategy modifier 1984. However, while supervised algorithmic techniques are possible, it is expressly contemplated that unsupervised algorithmic techniques may also be used—for example an image segmentation algorithm may be used in some embodiments herein.

Surface characterization data 1924 may also be stored in data store 1920, and may inform characterization of defects detected, and surface haze detected. Data store 1920 may also include one or more light source options 1926 that can be retrieved by controller 1960. For example, light source options 1926 may include possible angles with respect to image capturing device 1911, or between a first and second light source 1914. Data store 1920 may also include repair strategy components 1928, which may include repair strategies previously generated, and surface conditions associated with said repair strategies. Repair strategy data 1928 may be used to inform a machine learning algorithm powering repair strategy generator 1982 or repair strategy modifier 1984.

In some embodiments, surface imaging system 1900 outputs data to a display 1940, for example using a communication component 1902. Communication component 1902 may communicate with a graphical user interface generator 1944, which is illustrated as part of display 1940, but maybe part of controller 1960, a remote controller, or any other suitable computing device. A generated GUI may be displayed on display 1940 using user interface 1942.

A user may interface with system 1900, for example using user interface 1942. User interface 1942 may, for example, provide access to an application that can be used to control workflow by controller 1960. Additionally, user interface 1942 may be used to display captured images, results of image processing, associated metadata related to captured images, defect characterization information, etc.

Work surface 1990 may be a specular surface with reflective characteristics in some embodiments. Work surface 1990 may move during a surface modification operation, using movement mechanism 1994. For example, a vehicle may move from a first location to a second location along an assembly line. In embodiments where a work surface 1990 is mobile, a stabilizer 1990, or a stabilizing system, may be used to maintain a relative position of for work surface 1990 with respect imaging system 1910.

Surface inspection systems have been described herein that include image capturing devices, such as a camera, one or more light sources, distant sensors, etc. Systems and methods herein describe components for managing and executing capture of said images, and processing said images to obtain defect characterization information, and surface characterization information. Systems and methods herein have been described that can store and retrieve captured images, image metadata, defect detection and characterization results, and manipulate said information to generate or improve a repair strategy. Systems described herein are expressly contemplated to be interoperable with a controller of a robot arm to which they are mounted, and may in fact be controllable by said robot controller. Additionally, systems herein are contemplated to be interoperable with other system components of a robotic system.

Systems and methods herein enable coordination of machine vision equipment, image capture using efficient and highly mobile illumination conditions, and identification of surface characteristics and defects on specular surfaces.

However, it is expressly contemplated that systems and methods herein may be useful for other industries, for example while it is envisioned that the vehicle and use cases described herein are being repaired at an initial manufacturing site, it is also contemplated that an automotive aftermarket use case is also relevant. Additionally, recurring or constant evaluations of internal or external processes such as part repairs, evaluating metallic and/or paint finishes for other groups of products, or even high spatial resolution mapping of an environment using a mobile robot.

Further, it is contemplated that a surface imaging system herein may be useful for other specular surfaces, for example imaging a surface pre-and post-adhesive application, for example.

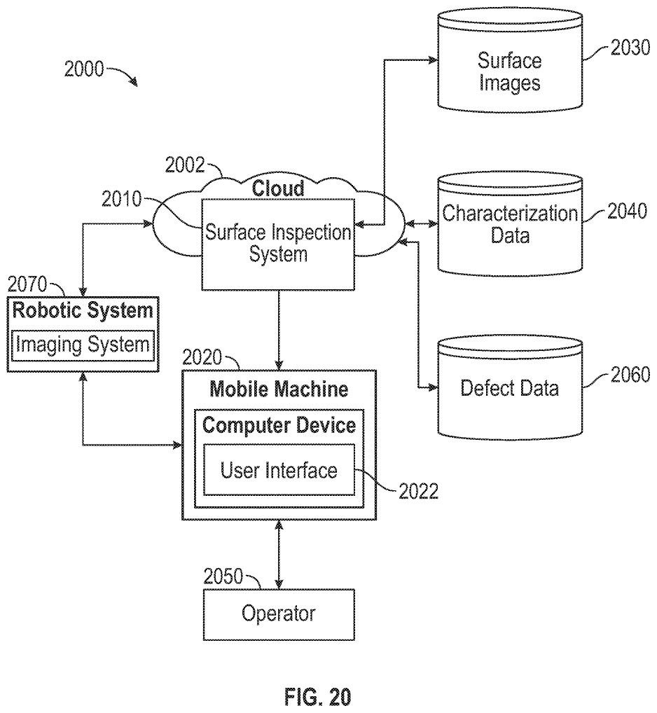

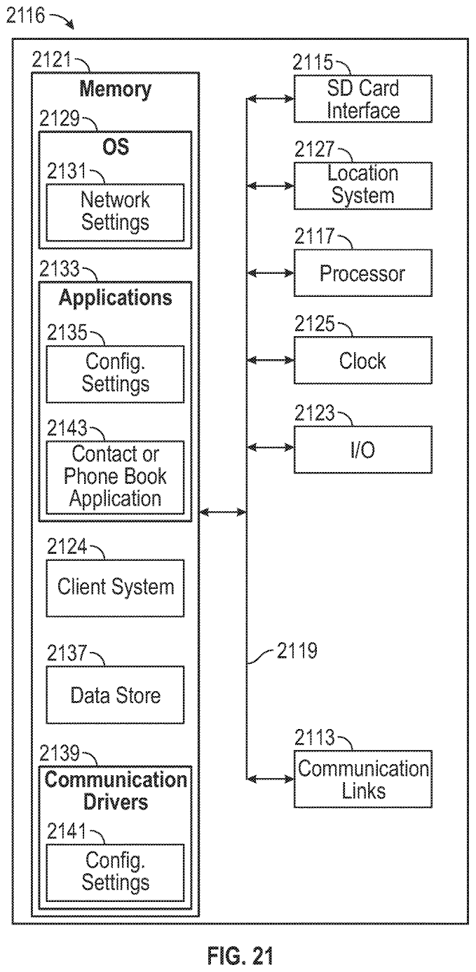

FIG. 20 is a block diagram of a repair strategy generation architecture. The remote server architecture 2000 illustrates one embodiment of an implementation of a repair strategy generator 2010. As an example, remote server architecture 2000 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-19 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 20, some items are similar to those shown in earlier figures. FIG. 20 specifically shows that a repair strategy generation system can be located at a remote server location 2002. Therefore, computing device 2020 accesses those systems through remote server location 2002. Operator 2050 can use computing device 2020 to access user interfaces 2022 as well.

FIG. 20 also depicts another example of a remote server architecture. FIG. 20 shows that it is also contemplated that some elements of systems described herein are disposed at remote server location 2002 while others are not. By way of example, storage 2030, 2040 or 2060 or repair systems 2070 can be disposed at a location separate from location 2002 and accessed through the remote server at location 2002. Regardless of where they are located, they can be accessed directly by computing device 2020, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

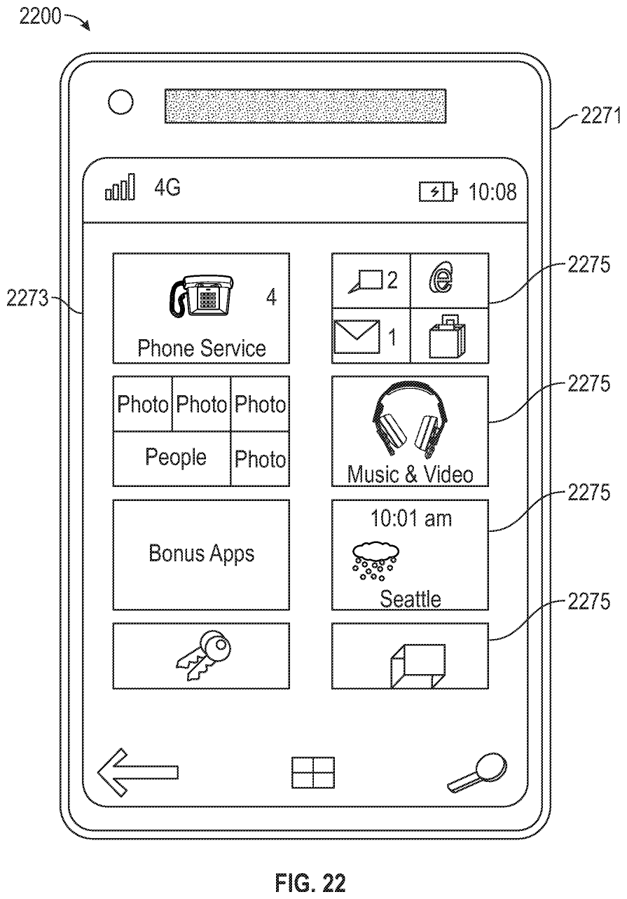

FIGS. 21-22 show examples of mobile devices that can be used in the embodiments shown in previous Figures.

FIG. 21 is a simplified block diagram of one illustrative example of a handheld or mobile computing device that can be used as a user's or client's handheld device 2121 (e.g., as computing device 2020 in FIG. 20), in which the present system (or parts of it) can be deployed. For instance, a mobile device can be deployed in the operator compartment of computing device 920 for use in generating, processing, or displaying the data. FIG. 17 is another example of a handheld or mobile device.

FIG. 21 provides a general block diagram of the components of a client device 2116 that can run some components shown and described herein. Client device 2116 interacts with them, or runs some and interacts with some. In the device 2116, a communications link 2113 is provided that allows the handheld device to communicate with other computing devices and under some embodiments provides a channel for receiving information automatically, such as by scanning. Examples of communications link 2113 include allowing communication though one or more communication protocols, such as wireless services used to provide cellular access to a network, as well as protocols that provide local wireless connections to networks.

In other examples, applications can be received on a removable Secure Digital (SD) card that is connected to an interface 2115. Interface 2115 and communication links 2113 communicate with a processor 2117 (which can also embody a processor) along a bus 2119 that is also connected to memory 2121 and input/output (I/O) components 2123, as well as clock 2125 and location system 2127.

I/O components 2123, in one embodiment, are provided to facilitate input and output operations and the device 2116 can include input components such as buttons, touch sensors, optical sensors, microphones, touch screens, proximity sensors, accelerometers, orientation sensors and output components such as a display device, a speaker, and or a printer port. Other I/O components 2123 can be used as well.

Clock 2125 illustratively comprises a real time clock component that outputs a time and date. It can also provide timing functions for processor 2117.

Illustratively, location system 2127 includes a component that outputs a current geographical location of device 2116. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 2121 stores operating system 2129, network settings 2131, applications 2133, application configuration settings 2135, data store 2137, communication drivers 2139, and communication configuration settings 2141. Memory 2121 can include all types of tangible volatile and non-volatile computer-readable memory devices. It can also include computer storage media (described below). Memory 2121 stores computer readable instructions that, when executed by processor 2117, cause the processor to perform computer-implemented steps or functions according to the instructions. Processor 2117 can be activated by other components to facilitate their functionality as well.

FIG. 22 shows that the device can be a smart phone 2271. Smart phone 2271 has a touch sensitive display 2273 that displays icons or tiles or other user input mechanisms 2275. Mechanisms 2275 can be used by a user to run applications, make calls, perform data transfer operations, etc. In general, smart phone 2271 is built on a mobile operating system and offers more advanced computing capability and connectivity than a feature phone.

Note that other forms of the devices 2216 are possible.

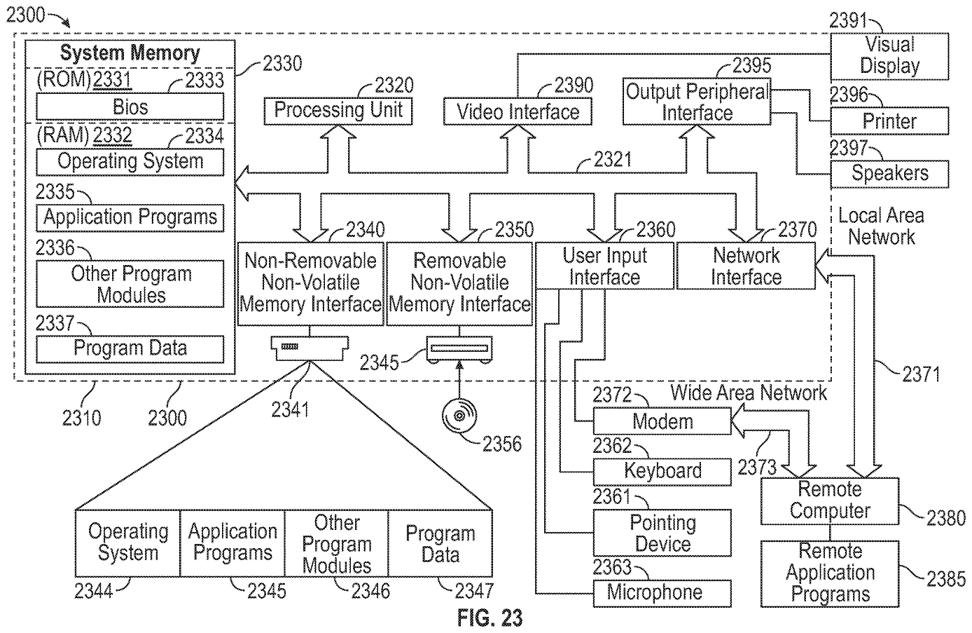

FIG. 23 is a block diagram of a computing environment that can be used in embodiments shown in previous Figures.

FIG. 23 is one example of a computing environment in which elements of systems and methods described herein, or parts of them (for example), can be deployed. With reference to FIG. 23, an example system for implementing some embodiments includes a general-purpose computing device in the form of a computer 2310. Components of computer 2310 may include, but are not limited to, a processing unit 2320 (which can comprise a processor), a system memory 2330, and a system bus 2321 that couples various system components including the system memory to the processing unit 2320. The system bus 2321 may be any of several types of bus structures including a memory bus or memory controller, a peripheral bus, and a local bus using any of a variety of bus architectures. Memory and programs described with respect to systems and methods described herein can be deployed in corresponding portions of FIG. 23.

Computer 2310 typically includes a variety of computer readable media. Computer readable media can be any available media that can be accessed by computer 2310 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2310. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 2330 includes computer storage media in the form of volatile and/or nonvolatile memory such as read only memory (ROM) 2331 and random access memory (RAM) 2332. A basic input/output system 2333 (BIOS) containing the basic routines that help to transfer information between elements within computer 2310, such as during start-up, is typically stored in ROM 2331. RAM 2332 typically contains data and/or program modules that are immediately accessible to and/or presently being operated on by processing unit 2320. By way of example, and not limitation, FIG. 23 illustrates operating system 2334, application programs 2335, other program modules 2336, and program data 2337.

The computer 2310 may also include other removable/non-removable and volatile/nonvolatile computer storage media. By way of example only, FIG. 23 illustrates a hard disk drive 2341 that reads from or writes to non-removable, nonvolatile magnetic media, nonvolatile magnetic disk 2352, an optical disk drive 2355, and nonvolatile optical disk 2356. The hard disk drive 2341 is typically connected to the system bus 2321 through a non-removable memory interface such as interface 2340, and optical disk drive 2355 are typically connected to the system bus 2321 by a removable memory interface, such as interface 2350.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 23, provide storage of computer readable instructions, data structures, program modules and other data for the computer 2310. In FIG. 23, for example, hard disk drive 2341 is illustrated as storing operating system 2344, application programs 2345, other program modules 2346, and program data 2347. Note that these components can either be the same as or different from operating system 2334, application programs 2335, other program modules 2336, and program data 2337.

A user may enter commands and information into the computer 2310 through input devices such as a keyboard 2362, a microphone 2363, and a pointing device 2361, such as a mouse, trackball or touch pad. Other input devices (not shown) may include a joystick, game pad, satellite receiver, scanner, or the like. These and other input devices are often connected to the processing unit 2320 through a user input interface 2360 that is coupled to the system bus, but may be connected by other interface and bus structures. A visual display 2391 or other type of display device is also connected to the system bus 2321 via an interface, such as a video interface 2390. In addition to the monitor, computers may also include other peripheral output devices such as speakers 2397 and printer 2396, which may be connected through an output peripheral interface 2395.

The computer 2310 is operated in a networked environment using logical connections, such as a Local Area Network (LAN) or Wide Area Network (WAN) to one or more remote computers, such as a remote computer 2380.

When used in a LAN networking environment, the computer 2310 is connected to the LAN 2371 through a network interface or adapter 2370. When used in a WAN networking environment, the computer 2310 typically includes a modem 2372 or other means for establishing communications over the WAN 2373, such as the Internet. In a networked environment, program modules may be stored in a remote memory storage device. FIG. 23 illustrates, for example, that remote application programs 2385 can reside on remote computer 2380.

An imaging system for a reflective surface is presented that includes a first light source, mounted to a robotic arm, a second light source, different from the first light source, mounted to the robotic arm, and an imaging device positioned to capture images of the reflective surface. The first light source, the second light source and the imaging device are mounted on a robotic arm the first light source is positioned, with respect to the imaging device, such that a field of view of the imaging device captures specular reflections from the first light source.

The imaging system may be implemented such that the second light source is positioned, with respect to the imaging device such that the field of view of the imaging device captures scatter illumination from the second light source.

The imaging system may be implemented such that the second light source is positioned between the imaging device and the first light source.

The imaging system may be implemented such that the first light source, the second light source, and the imaging device are contained at least partially within a housing, and the housing is mounted to a robotic arm.

The imaging system may be implemented such that the first light source includes a static structured light pattern.

The imaging system may be implemented such that the static structured light pattern includes a repeating pattern.

The imaging system may be implemented such that the repeating pattern includes lines, polygons, or circles.

The imaging system may be implemented such that the imaging system is mounted to an end effector of a robotic arm.

The imaging system may be implemented such that a surface modification tool is mounted to the end effector.

The imaging system may be implemented such that the end effector is configured to move from a first position the tool contacts the surface, to a second position, where the imaging system is configured to capture images.

The imaging system may be implemented such that it includes a controller that, based on the captured images, generates a trajectory for the tool.

The imaging system may be implemented such that the end effector is also configured to move to a third position, such that a second tool contacts the surface.

The imaging system may be implemented such that the end effector is also configured to move to a fourth position, such that a third tool contacts the surface.

The imaging system may be implemented such that the imaging device is a camera.

An imaging system for a reflective surface is presented that includes a mount configured to couple the imaging system to a robotic arm, a light source, coupled to the mount the light source illuminates the reflective surface and an imaging device positioned to capture images of the illuminated reflective surface.

The imaging system may be implemented such that the light source is a high intensity line light, and the light source is positioned such that a specular reflection is received by the field of view.

The imaging system may be implemented such that a diffuser plate is positioned in front of the light source.

The imaging system may be implemented such that the diffuser plate is a first diffuser plate and a light from the light source passes through the first diffuser plate before the second diffuser plate. A gap is between the first and second diffuser plates.

The imaging system may be implemented such that it includes a third diffuser plate, arranged in a stack such that light from the light source passes through the second diffuser plate before the third diffuser plate. A space between the second and third diffuser plates is the same as the gap.

The imaging system may be implemented such that the diffuser plate is removeable.

The imaging may be implemented such that a controller controls the robotic arm such that the imaging device is in line with a normal vector from the reflective surface.

The imaging system may also include a second light source the second light source is an area light source.

The imaging system may also include a structured light pattern placed between the second light source and the reflected surface.

The imaging system may be implemented such that the light source is coplanar with the imaging device.

The imaging system may be implemented such that the light source is positioned between the imaging device and the surface.

The imaging system may be implemented such that the imaging device images the surface through an aperture in the light source.

The imaging system may be implemented such that the imaging device is positioned normal to the light source.

The imaging system may be implemented such that the imaging device is angled with respect to the light source.

The imaging system may be implemented such that the imaging device is a first imaging device, and the imaging system further includes a second imaging device, at a second angle with respect to the light source.

The imaging system may be implemented such that the first imaging device and the second imaging device are cross-facing.

The imaging system may be implemented such that the first imaging system is offset from the second imaging system along a length of the light source.

The imaging system may be implemented such that the first imaging system is offset from the second imaging system along a width of the light source.

The imaging system may be implemented such that the first imaging device images the surface through a first portion of the light source, and the second imaging device images the surface through a second portion of the light source.

The imaging system may be implemented such that the first and second portions overlap.

The imaging system may be implemented such that the first portion is spaced apart from the second portion.

The imaging system may be implemented such that the first portion includes an aperture extending through the light source.

The imaging system may also include a movement mechanism.

The imaging system may be implemented such that the movement mechanism is configured to change a position or orientation of the imaging device.

A robotic surface modification system is presented that includes a robotic arm, a force control unit coupled to the robotic arm, an end effector coupled to the force control unit, and an imaging system mounted to the end effector the imaging system is configured to capture images of a surface.

The robotic system may be implemented such that the imaging system includes a housing mounted to the end effector the housing at least partially houses an imaging device and a light source.

The robotic system may be implemented such that the light source is positioned such that specular reflections from the area light are received by the imaging device.

The robotic system may be implemented such that the light source includes a structured light pattern.

The robotic system may be implemented such that the light source is a first light source, and further including a second light source the second light source is different from the first light source.

The robotic system may be implemented such that the second light source is a line light, and the second light source is positioned such that the imaging device receives scatter illumination.

The robotic system may also include a surface modification tool configured to, when aligned with the force control unit, modify the surface modifying includes adding or removing material from the surface.

The robotic system may also include a second surface modification tool, mounted to the end effector.

The system may be implemented such that the end effector rotatably moves between a first position, with the imaging system in line with a vector normal to the surface, and a second position, with the surface modification tool in line with the force control unit.

The system may also include a second tool, and the end effector is configured to rotatably move to a third position, with the second surface modification tool is in line with the force control unit.

The system may also include a fourth tool, and the end effector is configured to rotatably move to a fourth position, with the third surface modification tool is in line with the force control unit.

The system may also include a robot control unit configured to send movement instructions to the robotic arm.

The system may also include a robot control unit configured to send movement instructions to a rotation mechanism.

The system may also include an image analyzer that processes the captured images.

The system may also include a controller, based on the analyzed images, selects a trajectory for the surface modification tool for a surface modification operation on the surface.

The system may be implemented such that the image analyzer is configured to quantify an amount of haze on the surface.

The system may be implemented such that processing includes detecting a curvature of the surface based on the captured images.

The system may also include a position verification system including: a topography retriever that retrieves a known topography of the surface, and a position verifier that compares the detected curvature to the known topography.

The system may be implemented such that, based on a detection that the known topography differs from the detected topography, a surface modification trajectory is updated.

The system may be implemented such that updating the surface modification trajectory includes: changing a starting point, increasing a surface modification area, decreasing a surface modification area, or selecting a different trajectory.

The system may be implemented such that the imaging system includes a light source.

The system may be implemented such that the light source is coplanar with the imaging device.

The system may be implemented such that the light source is between the imaging device and the surface.

The system may be implemented such that the imaging device images the surface through the light source.

The system may be implemented such that the imaging device images the surface through an aperture in the light source.

A method of modifying a surface is presented that includes imaging the surface, a first time, using an imaging system mounted to a surface modification system, characterizing the surface, based on images captured by the imaging system, switching a relative position of the imaging system with a tool of the surface modification system, based on the characterization, conducting a surface modification operation, using the tool, imaging the surface, using the imaging system, a second time, and evaluating the surface modification system based on the second captured images.

The method may be implemented such that the imaging system includes an imaging device, a first light source, and a second light source the first light source is used for the first imaging step, and the second light source is used for the second imaging step, and the first and second light sources are different.

The method may be implemented such that the first light source is angled with respect to the imaging device during the first imaging step, such that the imaging device captures specular reflections.

The method may be implemented such that the second light source is angled with respect to the imaging device, during the second imaging step, such that the imaging device captures scatter illumination.

The method may be implemented such that the first light source includes a structured light pattern.

The method may be implemented such that the second light source includes a diffusion plate between the surface and the second light source.

The method may also include a second diffusion plate, spaced apart from the diffusion plate.

The method may also include a third diffusion plate, spaced apart from the second diffusion plate, on a side opposite the first diffusion plate, and a spacing between the first and second diffusion plates is similar to a spacing between the second and third diffusion plates.

The method may be implemented such that characterizing includes identifying a location of a surface defect.

The method may be implemented such that characterizing includes identifying a type of a surface defect.

The method may be implemented such that characterizing includes quantifying a haze of the surface.

A method of positioning an imaging system over a surface is presented that includes capturing an image of the surface with an imaging device, generating a surface topography, using a topography generator for the surface based on the captured image, retrieving a known surface topography of the surface, comparing the generated surface topography to the known surface topography, and based on a detected difference between the generated surface topography and the known surface topography, generating a deviation indication.

The method may also include retrieving a surface modification trajectory template for a surface modification system the surface modification trajectory template includes a starting point, a path and an area, and, based on the deviation indication, generating a new surface modification trajectory that includes changing one of the starting point, the path or the area.

The method may be implemented such that generating the surface topography includes fitting a bounding rectangle to a portion of the captured image the bounding rectangle includes an area that can capture a reflection of a light source on the surface.

The method may be implemented such that generating the surface topography includes generating an angle of rotation based on the bounding rectangle.

The method may be implemented such that generating the surface topography includes generating an area of the bounding rectangle.

The method may be implemented such that comparing includes determining that an imaging system including the imaging device is aligned to the surface.

The method may be implemented such that comparing includes determining that an imaging system including the imaging device is not aligned to the surface and, based on that comparison, transforming the image.

The method may be implemented such that generating the surface topography includes classifying the surface as concave when the area is greater than a maximum area on a flat surface.

The method may be implemented such that generating the surface topography includes classifying the surface as convex when the area is less than a maximum area on a flat surface.

The method may also include: storing the deviation indication.

The method may be implemented such that the deviation indication is one of a plurality of deviation indications, and the method further includes: retrieving the plurality of deviation indications, and detecting a deviation trend.

The method may be implemented such that the deviation trend is an increasing deviation over time, and the method further includes: modifying the surface modification trajectory template.

The method may be implemented such that the imaging device includes a gridded light source.

The method may be implemented such that generating the surface topography includes calculating a boundary area that captures a reflection of the gridded light source.

The method may be implemented such that generating the surface topography includes calculating an angle of rotation of the gridded light with respect to the boundary area.

A surface imaging system is presented that includes a first image capturing device, a light source configured to be positioned between the first image capturing device and a surface being imaged, a mount configured to couple the surface imaging system to a robotic arm. The first image capturing device images the surface through the light source.

The system may also include a second image capturing device.

The system may be implemented such that the second image capturing device is coplanar with the first image capturing device.

The system may be implemented such that the first image capturing device images the surface through a first portion of the light source, and the second image capturing device images the surface through a second portion of the light source.

The system may be implemented such that the first portion and second portion overlap.

The system may be implemented such that the first portion and second portion are spaced apart.

The system may be implemented such that the first portion and second portion are spaced apart along both a width of the light source and a length of the light source.

The system may be implemented such that the first portion includes an aperture extending through the light source.

The system may be implemented such that the light source includes a panel.

The system may be implemented such that the light source is transparent.

The system may be implemented such that the light source is configured to scatter light toward the surface.

The system may be implemented such that the light source prevents light scattering toward the first image capturing device.

The system may be implemented such that the panel includes a transparent panel, and the light source includes a light emitter, and the light emitter is positioned such that light is projected into the transparent panel.

The system may be implemented such that the panel includes a plurality of surface features configured to scatter light toward the surface.

The system may be implemented such that the first imaging device is angled, at a first angle, with respect to the light source. The second imaging device is angled, at a second angle, with respect to the light source.

The system may be implemented such that the first imaging surface is positioned along an axis normal to the light source.

The system may also include a third image capturing device.

1. An imaging system for a reflective surface, the system comprising:
a first light source, mounted to a robotic arm;
a second light source, different from the first light source, mounted to the robotic arm;
an imaging device positioned to capture images of the reflective surface;
wherein the first light source, the second light source and the imaging device are mounted on a robotic arm, wherein the first light source is positioned, with respect to the imaging device, such that a field of view of the imaging device captures specular reflections from the first light source.

2. The imaging system of claim 1, wherein the second light source is positioned, with respect to the imaging device such that the field of view of the imaging device captures scatter illumination from the second light source.

3. The imaging system of claim 1, wherein the second light source is positioned between the imaging device and the first light source.

4. The imaging system of claim 1, wherein the first light source, the second light source, and the imaging device are contained at least partially within a housing, and wherein the housing is mounted to a robotic arm.

5. The imaging system of claim 1, wherein the first light source comprises a static structured light pattern.

6. The imaging system of claim 1, wherein the imaging system is mounted to an end effector of a robotic arm, and where the end effector is configured to move from a first position tool contacts the surface to a second position, where the imaging system is configured to capture images, and further comprising a controller that based on the captured images, is configured to generate a trajectory for the tool.

7-16. (canceled)

17. A robotic surface modification system comprising:
a robotic arm;
a force control unit coupled to the robotic arm;
an end effector coupled to the force control unit;
an imaging system mounted to the end effector, wherein the imaging system is configured to capture images of a surface.

18. The robotic system of claim 17, wherein the imaging system comprises a housing mounted to the end effector, wherein the housing at least partially houses an imaging device and a light source.

19. The robotic system of claim 18, wherein the light source is positioned such that specular reflections from the area light are received by the imaging device.

20. The robotic system of claim 17, and further comprising a light source, wherein the light source comprises a structured light pattern.

21. The robotic system of claim 18, where the light source is a first light source, and further comprising a second light source, wherein the second light source is different from the first light source.

22. The robotic system of claim 21, wherein the second light source is a line light, and wherein the second light source is positioned such that the imaging device receives scatter illumination.

23. The robotic system of claim 17, and further comprising:
a surface modification tool configured to, when aligned with the force control unit, modify the surface, wherein modifying comprises adding or removing material from the surface.

24. The system of claim 17, and further comprising an image analyzer that processes the captured images, and wherein a controller based on the analyzed images, is configured to select a trajectory for the surface modification tool for a surface: modification operation on the surface.

25. (canceled)

26. The system of claim 24, wherein the image analyzer is configured to quantify an amount of haze on the surface.

27. (canceled)

28. The system of claim 27, and further comprising:
a position verification system comprising:
a topography retriever that retrieves a known topography of the surface; and
a position verifier that compares the detected curvature to the known topography.

29-33. (canceled)

34. A method of positioning an imaging system over a surface, the method comprising:
capturing an image of the surface with an imaging device;
generating a surface topography, using a topography generator for the surface based on the captured image;
retrieving a known surface topography of the surface;
comparing the generated surface topography to the known surface topography; and
based on a detected difference between the generated surface topography and the known surface topography, generating a deviation indication.

35. The method of claim 34, and further comprising:
retrieving a surface modification trajectory template for a surface modification system,
wherein the surface modification trajectory template comprises a starting point, a path and an area; and
wherein, based on the deviation indication, generating a new surface modification trajectory that comprises changing one of the starting point, the path or the area.

36. The method of claim 34, wherein generating the surface topography comprises fitting a bounding rectangle to a portion of the captured image, wherein the bounding rectangle comprises an area that can capture a reflection of a light source on the surface.

37. The method of claim 36, wherein generating the surface topography comprises generating an angle of rotation based on the bounding rectangle or generating an area of the bounding rectangle.

38. (canceled)
